(19) United States
(12) Patent Application Publication
(10) Pub. No.: US 2025/0370437 A1
(43) Pub. Date: Dec. 4, 2025

(54) TECHNICS AND SYSTEMS TO PROVIDE CONTEXTUAL INFORMATION OF SPACES AND OBJECTS UTILIZING SENSORS WITH MACHINE LEARNING

(71) Applicant: Latch Systems, Inc., New York, NY (US)

(72) Inventor: Jason Mitura, New York, NY (US)

(21) Appl. No.: 19/226,955

(22) Filed: Jun. 3, 2025

Related U.S. Application Data
(60) Provisional application No. 63/655,413, filed on Jun. 3, 2024.

(51) Int. Cl. G05B 19/418; G07C 9/30

(52) U.S. Cl. CPC G05B 19/4184; G07C 9/30; G05B 2219/2642

(57) ABSTRACT

Embodiments feature a device with a processing chip and embedded logic executing instructions. This chip utilizes a trained machine learning model for real-time analysis of sensor data streams (e.g., temperature, vibration, pressure), generating anomaly scores. Anomalies are identified, and upon detection, the chip autonomously initiates remedial actions such as deactivating compromised equipment, dispatching detailed notifications via email/SMS to personnel, interfacing with maintenance scheduling systems, or dynamically reconfiguring access credentials for authorized service entities. The device architecture supports over-the-air (OTA) updates for its machine learning models, and the processing chip can be integrated within the sensor assembly or an associated smart device.

### CROSS REFERENCE

This application claims the benefit of U.S. Provisional Patent Application No. 63/655,413, filed on Jun. 3, 2024, the entirety of which is incorporated herein by reference.

### BACKGROUND

Smart building systems leverage advanced technologies such as the Internet of Things (IoT), artificial intelligence (AI), and building automation to enhance the efficiency, comfort, and safety of commercial and residential buildings. These systems integrate various subsystems like HVAC, lighting, security, and energy management, allowing for centralized control and data-driven decision-making. By optimizing resource use and automating system responses, smart buildings can reduce energy consumption and maintenance costs while improving occupant experience.

Anomaly detection within smart building systems is a critical issue for maintaining operational efficiency and preventing faults or system failures. Anomalies can encompass unexpected changes in energy usage, system performance, or environmental conditions that may indicate underlying problems, such as equipment malfunction, security breaches, or inefficiencies. The complexity and interconnected nature of smart systems make it difficult to reliably identify true anomalies amidst the vast amounts of data generated.

However, dynamic and variable nature of building environments can result in both false positives and missed detections, complicating response efforts. Accurate anomaly detection requires continuously updating models to adapt to changing conditions and integrating feedback from human operators to refine decision-making processes. Developing robust, scalable anomaly detection methods is essential for the widespread adoption and reliable operation of smart building systems.

### BRIEF SUMMARY

In various embodiments, a smart building system is managed by continuously monitoring building systems or devices using anomaly detection sensors. When an anomaly is detected in one of the monitored systems or devices based on sensor data, the system automatically identifies a physical path from a starting location to the site of a malfunctioning device associated with the anomaly. The system can perform a remedial response, such as reconfiguring access permissions for secure access points along this path to allow an authorized entity to reach the malfunctioning device's location.

In some embodiments, a device includes a memory for storing instructions and a processing chip with logic configured to execute these instructions. The device runs a trained machine learning model, which has been trained using datasets of normal and anomalous sensor readings from sensors monitoring equipment or devices. The device receives real-time sensor data, analyzes it using the machine learning model to identify anomalies in the monitored equipment or device, and makes on-device decisions based on the identified anomalies, such as initiating a remedial response.

In certain embodiments, a method for localized anomaly detection and automated remedial action is performed by a processing chip. This chip, integrated within a sensor or smart device, executes a trained machine learning model trained on a dataset of normal operational patterns and known anomalous sensor readings from monitoring equipment. The chip continuously receives real-time sensor data reflecting the physical phenomena of the monitored equipment or device. It analyzes this data using the machine learning model to identify deviations from established normal patterns. If a deviation exceeds a predefined or dynamically adjusted threshold, it is classified as an anomaly. Upon identifying an anomaly, the processing chip autonomously initiates one or more on-device decisions as a remedial response.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system in accordance with embodiments.

FIG. 2 illustrates a routine in accordance with one embodiment.

FIG. 3A illustrates an example sensor assembly in accordance with embodiments.

FIG. 3B illustrates an example smart lock in accordance with embodiments.

FIG. 4 illustrates a routine in accordance with embodiments.

FIG. 5 illustrates a routine for updating a processing chip on an edge device in accordance with embodiments.

FIG. 6A illustrates an example system in accordance with embodiments.

FIG. 6B illustrates an example system in accordance with embodiments.

FIG. 7 illustrates a routine in accordance with embodiments.

FIG. 8 illustrates a routine in accordance with embodiments.

FIG. 9 illustrates a routine in accordance with embodiments.

FIG. 10 illustrates an aspect of the subject matter in accordance with embodiments.

FIG. 11 illustrates a routine in accordance with embodiments.

FIG. 12 illustrates a system in accordance with embodiments.

FIG. 13 illustrates an apparatus in accordance with one embodiment.

FIG. 14 illustrates an artificial intelligence architecture in accordance with one embodiment.

FIG. 15 illustrates an artificial neural network in accordance with one embodiment.

FIG. 16 illustrates a computer-readable storage medium in accordance with one embodiment.

FIG. 17 illustrates a computing architecture in accordance with one embodiment.

FIG. 18 illustrates a communications architecture in accordance with one embodiment.

### DETAILED DESCRIPTION

The following describes an integrated system for smart buildings that leverages sensors and predictive modeling for anomaly detection and enhanced operational efficiency. These anomaly detection sensors detect a variety of conditions and physical phenomena such as motion, sound, temperature, and pressure related to objects, devices, equipment, or spaces, generating data. This data, and possibly other data from other sources is used by a modeling system to train machine learning models that identify characteristics of the monitored environment or objects, predict future characteristics, and convey these predictions to user devices. The system can also use trained models and detect deviations from predictions based on new, real-time sensor data, signaling these deviations accordingly. A configuration process allows users to associate sensors with specific objects, often using a mobile application to capture images and link the sensor to the object identified.

A significant aspect of the system discussed herein is the capability for local processing of sensor data and execution of machine learning models directly on a processing chip integrated within a sensor or smart device (edge inferencing). This on-device processing allows for real-time analysis of sensor data to identify anomalies and make immediate decisions, such as shutting off a malfunctioning device or notifying a responsible entity, without the latency of sending data to a centralized server. This local processing enhances system responsiveness, reduces network bandwidth consumption, improves data privacy by keeping sensitive information localized, and ensures continued operation even if network connectivity is lost. A processing chip can be optimized for Artificial Intelligence (AI) workloads, enabling efficient execution of complex AI computations with lower power consumption.

Furthermore, the system provides automated and intelligent responses to detect anomalies. Upon anomaly detection, the system can automatically identify a physical path from a starting location to the malfunctioning device and reconfigure access permissions for secure access points along this path to allow authorized personnel to reach the location. This involves integrating with building information models, using path-finding algorithms, and dynamically updating access control lists for smart locks. Embodiments also describe a services platform system that manages over-the-air (OTA) updates for deploying new or retrained machine learning models to the processing chips on edge devices. This ensures that the AI models remain current with recent data and algorithmic advancements, maintaining their accuracy and effectiveness without requiring physical access to the devices.

Embodiments discussed including a number of technical advantages. For example, one significant technical advantage is the enhancement of system responsiveness and reliability through localized data processing. By integrating a processing chip within a sensor or smart device, a trained machine learning model can be executed directly at the device level. This “edge inferencing” allows for real-time analysis of sensor data to identify anomalies. As a result, the system can make on-device decisions, such as shutting off a malfunctioning device or notifying a responsible entity, without the latency associated with transmitting data to a centralized server. This localized processing capability ensures faster response times to critical events and allows the system to continue operating and detecting anomalies even if network connectivity is lost.

Another key technical advantage is the ability to proactively and efficiently manage building systems and device malfunctions through automated anomaly response. When an anomaly is detected by the system, it can automatically identify a physical path from a starting location to the malfunctioning device. Subsequently, the system can automatically reconfigure access permissions for secure access points along this identified path. This allows authorized personnel to quickly and securely access the location of the malfunctioning device. This automated process streamlines maintenance responses, reduces system downtime, and enhances building security by dynamically managing access based on real-time needs.

Finally, the system provides a robust mechanism for maintaining the accuracy and relevance of machine learning models on edge devices through over-the-air (OTA) updates. A services platform system manages the distribution of these updates, allowing for the deployment of new or retrained models to the processing chip without requiring physical access. This ensures that the models remain current with recent data and algorithmic advancements. Wireless communication protocols are used to transmit these models securely. This capability allows for seamless integration of model improvements, minimizes downtime, and supports the agile deployment of machine learning solutions, keeping edge devices equipped with state-of-the-art inferencing capabilities.

Embodiments are generally directed to systems and methods that provide a comprehensive solution for monitoring spaces and objects within building environments. It utilizes one or more sensors, advanced data processing, and machine learning models to gain insights into building conditions and occupancy characteristics, optimize resource utilization, identify object operation characteristics, and enhance safety and security.

The system includes the deployment of one or more sensors configured to monitor spaces or objects. Examples of sensors include environmental sensors to monitor temperature, humidity, air quality, light levels, etc., and occupancy sensors to monitor motion (motion detectors and/or infrared sensors). Additional sensors may include object-specific sensors, such as vibration sensors, pressure sensors, proximity sensors (attached to assets), etc.

The sensors are strategically deployed throughout the building, on specific objects of interest, and within spaces to be monitored. The sensors may continuously collect data about the environment and the status of objects and transmit data wirelessly (or wired) to a central hub or gateway using protocols like Wi-Fi, Zigbee, or Bluetooth. The sensors may also be connected with the cloud or backend services.

A system may process the data and apply machine learning techniques to generate and provide models to analyze the sensor data and perform functions such as forecasting future space utilization, object conditions, and potential issues. Additionally, the system may identify unusual patterns or events that deviate from expected norms, recognize and classify objects based on their sensor profiles, and link sensor data to specific objects for detailed monitoring.

The machine learning techniques may be utilized to analyze data from a diverse array of sensors. These sensors can be singularly focused, monitoring a specific space or an individual object within a building, or collectively arranged, with multiple sensors deployed across various locations within a structure. The aim is to accumulate and analyze data on a granular level—as in the case of a single sensor monitoring a specific room or piece of equipment—or on a macro level, where the data from the entire network of sensors deployed throughout the building is aggregated. This comprehensive data collection and analysis methodology allows for an in-depth understanding of the operational dynamics within the building, facilitating optimized energy usage, enhanced security measures, improved environmental controls, and superior operational efficiency. By applying machine learning algorithms to the data gathered, the system can predict future conditions, adapt to changes in real-time, and provide actionable insights to improve building management practices.

Embodiments further include a configuration or setup process that allows users to add new sensors to the system. The system utilizes machine learning to identify objects using computer vision and/or object detection techniques. A sensor may then be automatically linked to the identified object, establishing a relationship for continuous monitoring. These and other details will become more apparent in the following description.

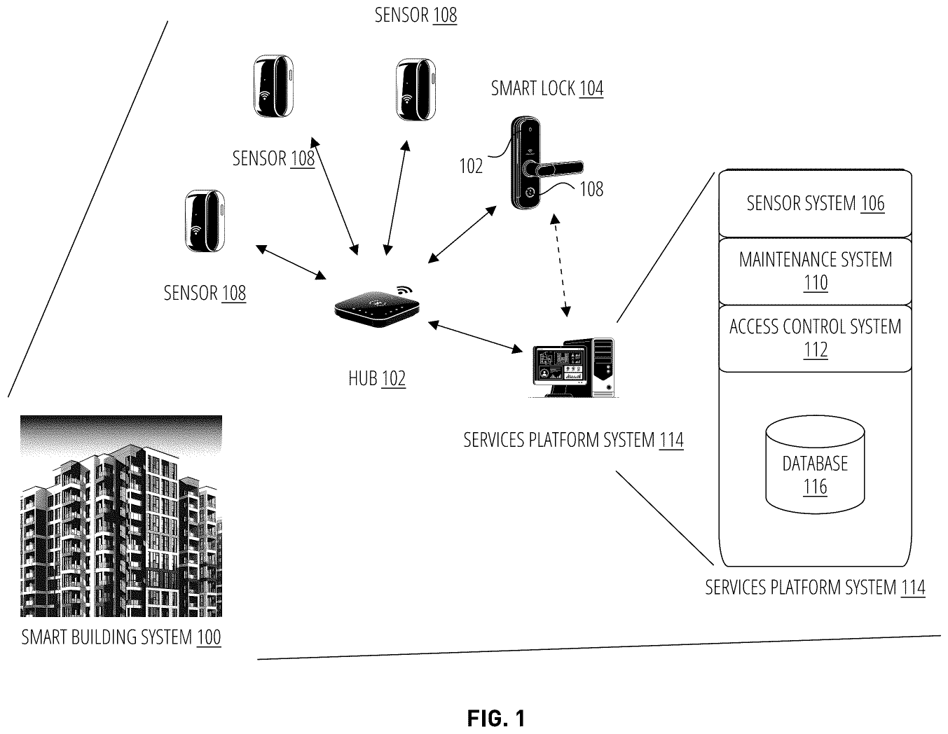

FIG. 1 illustrates an example of a smart building system 100 in accordance with the embodiments. The smart building system 100 may be configured to control various aspects of devices and sensors installed throughout a building. The smart building system 100 can be configured to control various aspects of devices and sensors installed throughout a building. This includes lighting systems, which can be controlled to optimize energy efficiency and occupant comfort by regulating brightness, color, and scheduling. Heating Ventilation, and Air Condition (HVAC) systems can also be integrated into the system, allowing for temperature, humidity, and air quality to be regulated to maintain a comfortable indoor environment. Additionally, security systems, including access control, motion detectors, and alarm systems, can be monitored and controlled to ensure building safety. The system can also be integrated with energy management systems, which track and manage energy consumption in real-time, enabling optimized energy usage and reduced costs. Environmental monitoring systems can be used to track indoor air quality, temperature, humidity, and other environmental parameters. Audio-visual systems can be controlled to optimize the building's ambiance and user experience, with lighting, temperature, and acoustics being adjusted accordingly.

Furthermore, the smart building system 100 can be integrated with building automation systems (BAS), which integrate and control various building systems to optimize energy efficiency, occupant comfort, and building performance. Internet of Things (IoT) devices, such as sensors, cameras, and access control systems, can also be integrated into the system to provide real-time monitoring and control capabilities.

All these systems including its devices require monitoring to insure they are operating and detecting anomalies which may indicate a malfunctioning device. Embodiments of the present disclose a smart building system 100, which comprises one or more anomaly detection sensors 108 strategically integrated throughout the building infrastructure. These sensors are specifically designed to continuously monitor various the systems or devices, such as HVAC, lighting, security, and energy management systems.

Each of the sensors 108 may be configured to monitor and provide feedback for one or more systems and devices throughout the building infrastructure. In certain embodiments, a sensor 108 can exist as a standalone unit affixed directly to the system or device it monitors. This setup allows for focused and precise data collection, as the sensor is positioned to directly interact with the specific system or environmental factor it is intended to monitor. Standalone sensors can be strategically placed in locations such as HVAC units, pipelines, or lighting systems, where direct and constant monitoring is crucial for maintaining operational efficiency and safety.

Alternatively, sensors 108 can be embedded directly within a device, integrating seamlessly with the device's existing architecture. For example, a sensor might be embedded within a smart lock, such as the smart lock 104 illustrated in FIG. 1. In this configuration, the sensor not only monitors environmental conditions surrounding the lock, such as temperature and humidity, which can affect lock performance, but also provides feedback on the lock's operational status, security breaches, or unauthorized access attempts. By embedding sensors within devices, the design can enhance both functionality and security without requiring additional external components, which can simplify installation and maintenance.

The sensors 108 are capable of detecting deviations from normal operating conditions, identifying potential issues before they develop into significant problems. By employing advanced algorithms and data analytics, the sensor 108 analyze patterns and trends in the collected data, enabling the early identification of irregularities. This proactive approach facilitates predictive maintenance strategies, allowing building managers to address potential failures in a timely manner, thus minimizing downtime and maintenance costs.

The sensor 108 may be any type of sensor configured to detect environmental characteristics of systems and devices deployed in a building. These include temperature sensors that monitor ambient temperatures across different areas to ensure HVAC systems maintain desired climate conditions, and humidity sensors, which measure moisture levels in the air, aiding in the regulation of air quality and preventing mold growth. Pressure sensors are commonly used in HVAC systems to ensure optimal airflow and detect potential blockages or leaks. Light sensors detect natural and artificial light levels to optimize lighting systems for energy efficiency and occupant comfort. Air quality sensors assess indoor air quality by measuring pollutants, particulate matter, carbon dioxide levels, and volatile organic compounds (VOCs) to maintain a healthy environment. Motion and occupancy sensors track movement and occupancy patterns to optimize lighting and HVAC settings based on real-time usage, enhancing both energy efficiency and security. Additionally, sound sensors are used to monitor noise levels to ensure acoustic comfort in various building zones and to support noise control measures. Vibration sensors detect mechanical vibrations in machinery, such as elevators and HVAC equipment, for predictive maintenance purposes. Smoke and gas sensors provide early detection of smoke or harmful gases for fire safety and hazardous condition alerts.

This feedback capability involves the continuous collection and transmission of data related to the specific environmental characteristics being monitored by each sensor 108. This data may provided to systems of smart building system 100 including services platform system 114. In embodiments, the sensor 108 may communicate data with services platform system 114 via one or more wireless and/or wired connections.

In some instances, sensor 108 may be part of a mesh network, allowing it to communicate with other sensors and devices throughout the building. This communication structure enables data to be relayed efficiently from sensor to sensor, maximizing coverage and reliability even when direct communication with a central system is not feasible due to distance or obstructions. Within this mesh network, sensor 108 can transmit collected data to a centralized services platform system 114, which uses this information to monitor building systems' health and perform predictive maintenance. By accessing real-time data, the services platform system 114 can rapidly identify potential issues, optimize resource allocation, and schedule necessary interventions, thereby minimizing downtime and extending the lifespan of building systems.

In another example, sensor 106 may communicate with a hub 102. This hub acts as a central node that aggregates data from multiple sensors and devices, facilitating a more streamlined and organized approach to building management. The hub 102 can operate as a standalone component, strategically located to serve as a focal point for sensor communications, ensuring efficient data processing and transmission to the building's management systems. Alternatively, the hub 102 can be integrated into a smart device, such as a smart lock 104, allowing it to leverage the device's existing network connections and computing capabilities. By employing a hub integrated into a smart device, the system reduces hardware redundancy and installation complexity. This integration facilitates seamless communication between the sensor 106 and other smart devices, enabling coordinated actions and automated responses to environmental changes or security threats.

The sensor 108 and hub 102 within the smart building system 100 can communicate using various wired and wireless protocols such as Wi-Fi, Bluetooth, and LoRa, each selected based on specific operational needs and environmental conditions. Wi-Fi is suitable for high-speed data transfer over extended distances, making it ideal for integrating sensors into existing network infrastructures in office or residential buildings. Bluetooth provides short-range, power-efficient communication, beneficial for battery-operated sensors and personal area networks, such as those involving smart locks or nearby room sensors. LoRa offers long-distance communication with low power consumption, advantageous for large buildings or campuses where sensors are widely dispersed and where extensive wiring running is impractical. Additionally, wired protocols may be utilized where stable, secure, and low-latency communication is essential, such as in critical systems like fire alarms or security networks. By employing a range of communication protocols, the system ensures flexible and reliable data exchange between sensors and hubs, thus enhancing the operational effectiveness of the smart building's infrastructure.

In various embodiments, the services platform system 114 integrates multiple subsystems to enhance the overall functionality and management of a smart building. This platform includes a sensor system 106, a maintenance system 110, and an access control system 112, each playing a role in ensuring the efficient, secure, and seamless operation of the building including monitoring sensors, detecting anomalies, and deploying a fix without user interaction.

The sensor system 108 may be the same as or similar to system 600. Specifically, the sensor system 106 may utilize algorithms and models to detect anomalies based on historical data, current data and making inferences, as discussed herein. The sensor system 106 leverages historical data and real-time data to discern irregularities or unexpected patterns. By analyzing past data trends and comparing them with current data inputs, the systems employs predictive analytics to identify anomalies. Inferences are drawn from the processed information to improve reliability and decision-making. This approach enhances the ability to preemptively address potential issues or optimize system performance, ensuring efficiency and accuracy in complex environments.

The maintenance system 110 analyzes the outputs from the sensor system 106 to formulate appropriate corrective actions for detected anomalies. In scenarios where immediate intervention is required, the maintenance system 110 can implement short-term corrective actions. These actions might include automatically shutting off a valve in the event of a detected water leak, closing fire-safe doors if a fire is detected, or disconnecting power to a malfunctioning appliance to prevent further damage.

For long-term solutions, the maintenance system 110 extends beyond immediate responses by identifying the responsible entity or individual associated with the problematic device or system. In one example, the maintenance system 110 may determine an association between the device and an entity to resolve issues with the device in a data store or technician database 116. In this scenario, the maintenance system 110 leverages a data store or technician database 116 to establish a connection between a malfunctioning device and the associated entity responsible for its maintenance or ownership. This association enables the system to access relevant details for addressing the device's issues efficiently. The data store or technician database 116 contains comprehensive information about each device, such as its operational history, technical specifications, warranty details, and the contact information for responsible entities or individuals. By determining these associations, the maintenance system 110 can quickly identify the appropriate service provider or in-house technician qualified to handle the specific technical problem. Once the relevant entity is identified, the system can initiate communication to arrange for diagnostic procedures, repair services, or maintenance checks. The maintenance system 110 may send a communication to the relevant parties using various channels such as phone calls, text messages, multimedia messages, or emails. This communication aims to coordinate a maintenance appointment or repair service, ensuring that the issue is addressed comprehensively to prevent recurrence. The maintenance system 110 may deploy an automatic scheduling and/or emergency response platform to schedule a fix for the malfunctioning device.

The maintenance system 110 may incorporate an automatic scheduling and emergency response platform to streamline the process of addressing device malfunctions. This platform utilizes a systematic approach to coordinate and schedule repairs or maintenance activities efficiently. Once an anomaly is detected and a corresponding need for intervention is identified, the platform can automatically arrange for the necessary maintenance services. This automated scheduling involves real-time coordination with repair personnel, taking into account factors such as availability, proximity, and expertise required for the task. In situations where immediate action is critical, such as emergencies, the system can prioritize urgent fixes by dispatching available resources promptly. Additionally, the platform can manage communication with relevant stakeholders, ensuring that all involved parties are informed and can prepare accordingly.

The services platform system 114 represents a comprehensive infrastructure designed to manage and support various operational services within a facility. A component of this platform is the integrated access control system 112, specifically engineered to govern and facilitate physical access to secured areas and equipment. This access control system 112 is particularly valuable in scenarios requiring maintenance or repair of malfunctioning devices, enabling authorized personnel, such as internal technicians or external contractors, to reach their designated work areas efficiently and securely.

One capability of the access control system 112 is its automated path identification. Upon receiving a service request or an alert about a malfunctioning device—signaled by the sensor system 106—the access control system 112 intelligently determines the most efficient and permissible physical route. This process typically starts from a designated building entrance or the entity's last verified location within the facility and extends to the precise room or area housing the target device. Technically, this often involves integration with Building Information Modeling (BIM) data or a facility's digital twin, providing detailed floor plans, room layouts, and the locations of secure access points. To further refine pathfinding or verify an entity's starting point, Indoor Positioning Systems (IPS) utilizing technologies like Wi-Fi round trip time (RTT), Bluetooth Low Energy (BLE) beacons, or Ultra-Wideband (UWB) tags may be employed. Sophisticated pathfinding algorithms, such as A* or Dijkstra's, calculate the optimal path, considering factors like clearance levels, time-of-day restrictions, and even real-time facility status updates if integrated. The resulting path can then be visually displayed on a mobile application for the technician or communicated as a series of waypoints.

Once the optimal path is established, the access control system 112 identifies all electronically controlled secure doors, or other access barriers situated along this specific route. It then dynamically reconfigures the access permissions for these identified points to allow passage for the authorized entity during the scheduled service window. This is achieved through communication with individual door controllers, e.g., smart locks. The access control system 112 effectively updates the Access Control Lists (ACLs) associated with these controllers, either by pushing temporary credential identifiers (IDs), modifying access levels, or issuing specific override commands. The access control system 112 can also manage access zones, ensuring, for example, that access to a subsequent door is granted only after an entity has successfully navigated a preceding checkpoint. For high-security zones, features like door interlocking can be temporarily managed to facilitate authorized passage while maintaining overall security integrity.

The access control system 112 offers several mechanisms for granting temporary access, providing flexibility to accommodate diverse operational needs and security protocols. One method is access code provisioning, where the access control system 112 generates a unique, time-limited alphanumeric or numeric PIN. This code, created using random generation algorithms to ensure unpredictability, is securely communicated to the entity-via an encrypted text message to a pre-registered mobile number (technician database 116) or through a dedicated secure mobile application. The entity then enters this code at keypads installed at the relevant doors, with each code usage attempt logged for auditing. Entry of the code may include wireless communication of the code from a device to the access lock, e.g., NFC. These codes are typically single-use or session-specific and have a brief validity period tied to the maintenance schedule.

Another prevalent method leverages pre-existing identifying information associated with the entity, such as an employee or contractor badge code or enrolled biometric data. In this scenario, the access control system 112 interfaces with an identity management system or a personnel or technician database 116 containing these credentials. When a service call is assigned, the access control system 112 dynamically updates the access rights linked to the entity's badge ID (e.g., proximity or smart card number) or biometric profile (e.g., fingerprint or facial recognition data). This grants temporary permissions specifically for the doors along the identified path and for the scheduled duration. When the entity presents their badge to a reader or uses a biometric scanner, the system verifies their authorization in real-time or against recently updated local controller data. Supported technologies include various card types, NFC-enabled mobile credentials, and diverse biometric scanners.

A third option involves scheduled unlocking, sometimes referred to as “corridor mode” or “free access.” For pre-arranged maintenance windows, especially if multiple personnel require access or if an entity lacks a standard credential, the access control system 112 can be programmed to automatically unlock all doors along the designated pathway for a specified period. This relies on a robust scheduling engine within the control system, allowing for defined precise start and end times. During this window, the access control system 112 sends commands to the relevant door controllers to switch them to an unlocked state, automatically reverting them to their secured status upon expiration of the scheduled time. Due to the inherent security risks, this method is typically used sparingly, for minimal durations, and often accompanied by enhanced monitoring like CCTV surveillance of the pathway. An important variation could involve a “first-in” unlock, where doors along the path unlock only after the authorized entity successfully authenticates at the initial access point.

Supporting these functionalities are several critical technical elements. The access control system 112 relies on a secure and resilient network infrastructure, often utilizing network segmentation to isolate access control traffic. A central server (not shown), either on-premises or cloud-based, usually hosts the main application logic, database, and administrative interface. Robust encryption protocols, such as secure sockets layer/transport layer security (TLS/SSL), are essential for all communications between system components. Power backup systems like UPS are crucial for door controllers and locking mechanisms to ensure continuous operation and security during power outages, adhering to fail-safe or fail-secure principles as required by safety regulations. Comprehensive event logging and auditing capabilities are paramount, recording all access attempts, system changes, and errors with detailed timestamps and identifiers for security analysis and compliance. Finally, the services platform 114 and the access control system 112 often feature APIs to enable seamless integration with other enterprise systems, building automation systems, and Security Information and Event Management (SIEM) solutions.

In these embodiments, the services platform system 114 is designed as a cloud-based solution, offering an integrated and automated approach to managing and optimizing devices, systems, and equipment. This platform leverages the power of the cloud to provide seamless end-to-end functionality through several key components. Firstly, the system utilizes an extensive array of sensors distributed across various operational environments to continuously monitor and collect data on critical parameters such as temperature, pressure, performance metrics, and more. These sensors serve as the eyes and ears of the platform, providing real-time insights into the status of equipment and systems. With the data collected from sensors, the platform employs sophisticated algorithms and machine learning models designed to identify anomalies or irregularities in device operations. These models analyze patterns and deviations from established norms, enabling early detection of potential issues that may lead to system failures or inefficiencies.

By operating in the cloud, the services platform system 114 benefits from enhanced processing power and scalability. This architecture allows it to manage vast datasets and perform complex analyses quickly, offering reliable performance even during peak data loads. Once an anomaly is detected, the platform automatically determines the appropriate corrective actions. These actions might include notifying maintenance personnel, adjusting system parameters, shutting down equipment to prevent damage, or initiating repair workflows. The system supports interoperability with various types of equipment, systems, and devices, facilitating a unified platform for monitoring and management. This allows for a comprehensive approach to operational oversight, integrating data from multiple sources into a coherent framework. The cloud-based nature of the platform ensures it can scale to accommodate varying numbers and types of devices. Additionally, it offers the flexibility to be customized according to specific industry requirements or operational constraints. Robust security measures are implemented to protect data integrity and privacy within the cloud environment. Compliance with industry standards and regulations is prioritized to ensure the system meets legal and operational requirements. Overall, the cloud-based services platform system 114 enhances operational efficiency, reliability, and safety by providing a proactive and automated approach to equipment and system management.

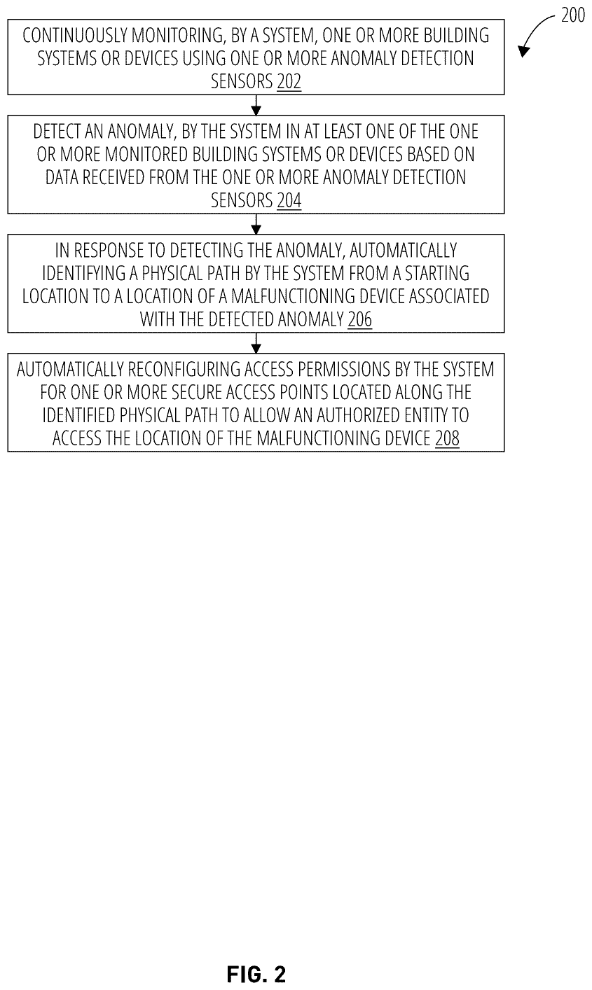

FIG. 2 illustrates an example of a routine 200 in accordance with embodiments. In block 202, routine 200 continuously monitoring, by a system, one or more building systems or devices using one or more sensors, such as an anomaly detection sensor. Continuously monitoring building systems or devices using anomaly detection sensors involves a systematic approach to ensure operational efficiency and detect potential malfunctions promptly. This typically includes the integration of various technologies and methodologies. For example, as discussed above, an array of anomaly detection sensors is deployed across the building systems. These sensors can measure parameters such as temperature, humidity, pressure, vibration, and electrical load. Sensors continuously collect real-time data and transmit it to a central processing unit such as the services platform system, utilizing wired or wireless communication protocols like Zigbee, LoRa WAN, or BACnet, depending on the application and scale. In some instances, processing may occur locally by an integrated AI chip.

In block 204, routine 200 detects an anomaly, by the system in at least one of the one or more monitored building systems or devices based on data received from the one or more anomaly detection sensors. In embodiments, the raw data from sensors is filtered and processed to reduce noise and enhance relevant features. Techniques such as Fast Fourier Transform (FFT) for vibration analysis or Kalman filtering for smoothing time-series data are commonly used. Machine learning algorithms, including supervised, unsupervised, and reinforcement learning models, then analyze the processed data to detect deviations from the norm. Common methods include Principal Component Analysis, Support Vector Machines, and neural networks like Long Short-Term Memory (LSTM) networks designed for time-series anomaly detection. The system uses predefined threshold levels to trigger alerts in case of anomaly detection. These thresholds are established based on historical data, manufacturer specifications, or adaptive learning models that adjust to evolving system behaviors. A dashboard visualizes the data and the results of anomaly detection, often integrating with Building Management Systems (BMS), providing building managers with insights into system performance, potential issues, and operational trends. Moreover, by analyzing historical and real-time data, the system can predict potential failures and schedule maintenance activities proactively, minimizing downtime and optimizing resource allocation.

In block 206, routine 200 in response to detecting the anomaly, automatically identifying a physical path by the system from a starting location to a location of a malfunctioning device associated with the detected anomaly. Automatically identifying a physical path involves several stages of technological integration and process execution designed to streamline maintenance responses and reduce system downtime. Upon detecting an anomaly through the sensors and analyzing the data, the system initiates an automated sequence to establish a clear and efficient route from a designated starting location to the site of the malfunction. The process begins with the anomaly detection system linking the anomaly to a specific device or location within the building infrastructure. Embodiments include cross-referencing sensor data with a database that maps sensor locations to physical building layouts. Once the location of the anomaly is determined, the system identifies the starting point, which may be based on the real-time location of available maintenance personnel or autonomous maintenance units. For mapping the route, in some embodiments, the system utilizes digital representations of the building, such as 2D floor plans or 3D models. These models provide detailed spatial data, allowing the system to analyze potential routes by considering various physical constraints, such as walls, doors, and restricted-access areas. Advanced pathfinding algorithms, like Dijkstra's or the A* algorithm, calculate the most efficient path from the starting location to the malfunctioning device. These algorithms consider factors such as distance, accessibility, and time required to traverse different parts of the building. The chosen path prioritizes speed and safety, ensuring maintenance personnel or robots can reach the anomaly site without unnecessary detours. Once the optimal path is determined, instructions are communicated to the responsible parties. This could involve sending directions to a technician's mobile device through text or a graphical navigation app.

In block 208, routine 200 automatically reconfiguring access permissions by the system for one or more secure access points located along the identified physical path to allow an authorized entity to access the location of the malfunctioning device. Upon identifying the optimal path to the malfunctioning device, the system evaluates each access point along this route. These access points could include doors, gates, or other barriers typically controlled with electronic locks or security systems. In a standard configuration, these points might restrict access based on predefined security levels or access permissions set for routine operational periods. To allow an authorized entity to access the malfunction site, the system temporarily reconfigures these permissions. This reconfiguration begins with the verification of the entity's credentials, such as through RFID badges, biometric scans, or mobile credentials. The system ensures that the credentials match predefined authorization criteria aligned with emergency access protocols or roles with elevated permissions, such as maintenance, security, or IT support. Once verified, the system communicates with the electronic locking mechanisms via the building's access control system. Using secure communication protocols, like TLS or other encrypted channels, the system sends commands to adjust the access permissions for only the specific doors or barriers along the identified path. This might involve temporarily unlocking doors or adjusting access criteria to accept the authorized entity's credentials for the duration required to address the anomaly, as discussed herein.

In some instances, the system logs each access event, including times and entities accessing each point, ensuring traceability and compliance with security policies. After the authorized entity completes their task at the malfunctioning device's location, the system can automatically restore the original access configuration to uphold normal security protocols. Furthermore, if integrated with a facility's broader security management infrastructure, this functionality can be extended to provide real-time status updates to security personnel, enabling them to monitor and, if necessary, control spontaneous changes in access permissions, thereby maintaining a secure environment while efficiently managing the anomaly response.

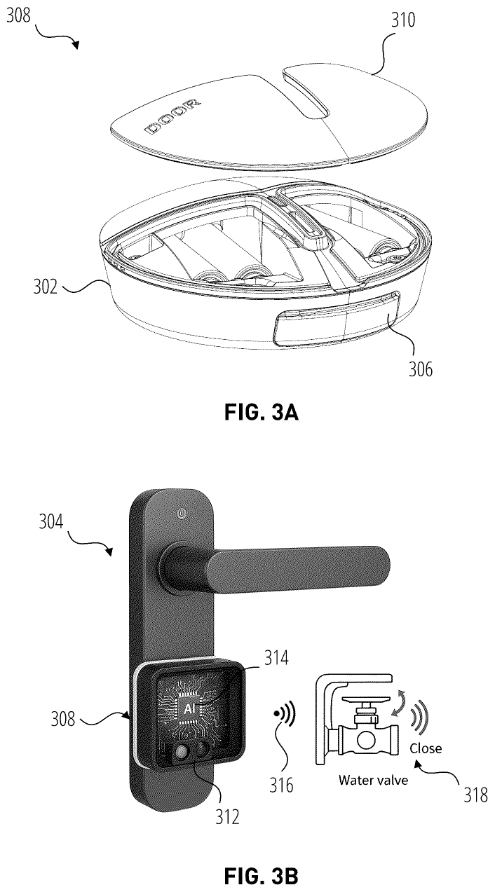

FIG. 3A illustrates an example embodiment of a sensor assembly 308, which may include one or more sensors discussed herein. The sensor assembly 308 may represent sensors 108 and 608. The sensor assembly 308 is an AI-powered indoor sensor designed to detect and report various household issues, including running toilets, leaks, and acoustic events. Its mechanical design emphasizes reliability, modular installation, ease of maintenance, performance, durability, and aesthetic integration within residential settings. The enclosure 302 is made from PC+ASA plastic via injection molding and features a removable magnetic bezel that serves as a customizable battery cover 310, allowing for tool-free battery access. It also includes an acoustic and airflow vent protected by a splash- and dust-proof mesh guard 306 for IP54 compliance, and a status RGB LED.

The sensor 308 includes two modular mounting solutions: a standard wall/furniture mount using a sheet metal steel bracket attachable by screws or double-sided adhesive tape, and a secondary suction cup mount for smooth indoor surfaces like glass or ceramic tile. Both systems utilize strong integrated magnets for secure placement and easy, tool-free removal of the device from the bracket. The sensor array includes a gas sensor, a temperature and humidity sensor, a microphone, and two water leak detection sensors (one integrated and one with a lasso). Power is supplied either by batteries, accessible via the magnetic bezel, or through a USB Type-C port, accessible via a rubber cap. The device is designed to operate in temperatures ranging from 0° C. to 60° C. and has an IP54 ingress protection rating against dust and water splashes.

As previously mentioned, embodiments include one or more sensors that may be placed in an environment, affixed to a device, equipment, etc. These sensors may communicate with a services platform system either via a hub or directly via network, such as a mesh network. In embodiments, the services platform system provides modeling, inferencing, malfunction detection and resolution, etc. In other instances, one or more of the operations performed by the services platform system may be performed locally via an integrated circuit or embedded processing chip in a hub or another smart device, e.g., smart lock 304. FIG. 3B illustrates example of a smart lock 304 including an integrated processing chip 314.

In these instances, an integrated circuit or embedded processing chip 314 manages one or more of these functions. For example, a smart lock 304 including a processing chip 314 enables independently handle of operations like inferencing and malfunction detection directly at the device level. The processing chip 314 processes and manage the device's essential functions and/or other devices nearby, make real-time decisions based on incoming data, and even continue operating if network connectivity is lost. Such local processing significantly reduces latency, making it ideal for time-sensitive applications where immediate responses are crucial.

In embodiments, the processing chip 314 performs Artificial Intelligence (AI) operations, particularly for inferencing. It runs pre-trained machine learning models directly on the device, allowing it to analyze new, live data and make intelligent judgments or predictions from nearby sensors. This “edge inferencing” offers substantial benefits, including enhanced data privacy by keeping sensitive information localized, and reduced network bandwidth consumption as only pertinent results or alerts need to be transmitted. The processing chip 314 is architecturally optimized for AI workloads, featuring specialized units like Neural Processing Units (NPUs) or Digital Signal Processors (DSPs) with AI acceleration, enabling it to execute complex AI computations efficiently and with lower power consumption.

One of the primary applications of the AI capabilities within chip 314 is the detection of malfunctions in other equipment or devices via sensor data. The smart device 304 utilizes one or more sensors to collect continuous data streams—such as temperature, vibration, or pressure readings—from the monitored equipment. The AI model embedded in chip 314 then meticulously analyzes this sensor data in real-time to identify anomalies, which are deviations from established normal operating patterns. These anomalies could manifest as unusual spikes, drops, or altered patterns in sensor readings. Upon detecting a significant anomaly, the AI can often infer the nature and location of the potential malfunction, and initiate protective actions like adjusting operational parameters or shutting down the compromised equipment to prevent further damage, and automatically deploying an entity to resolve the problem. This capability can also extend to predictive maintenance, where the AI learns patterns preceding failures, enabling proactive servicing and minimizing downtime.

In some embodiments, each sensor or sensor assembly 308 associated with a device or equipment may be equipped with a processing chip 314, enabling it to perform localized inferences specific to its corresponding device or equipment. Each processing chip 314 performs localized inferences through data analysis and pattern recognition specific to its corresponding device or equipment. The processing chip 314 is further configured with machine learning models tailored to the operational parameters of the device, allowing real-time decision-making and anomaly detection.

The capacity for on-device decision-making is enabled by an integrated AI processing chip 314 embedded within each piece of hardware, transforming the sensor into an intelligent edge device. These processing chip 314 are not general-purpose processors but specialized microprocessors optimized for efficiently executing artificial intelligence algorithms. They can range from Microcontroller Units (MCUs) enhanced with AI acceleration features, such as dedicated instructions for neural network operations or co-processors like ARM's Ethos-U NPU, to Application-Specific Integrated Circuits (ASICs) custom-designed for specific AI tasks like anomaly detection. Other options include Field-Programmable Gate Arrays (FPGAs) offering reconfigurable AI acceleration, or low-power AI System-on-Chips (SoCs) that bundle CPU cores, memory, and AI accelerators.

This specialized hardware facilitates local autonomous inference, where the sensor directly analyzes data using a pre-trained machine learning model stored on the processing chip 314 itself. Embodiments, the services platform system 114 trains a suitable model (e.g., neural network, SVM) offline using a comprehensive dataset of normal and anomalous readings. The trained model is then optimized for the resource-constrained edge environment through techniques like pruning (reducing model complexity) and quantization (converting parameters to lower-precision numbers), significantly shrinking its size and computational demands. The services platform system 114 deploys the model to a sensor. An on-device inference engine, which is lightweight runtime software, executes this optimized model. When the sensor collects raw data, it may first undergo on-chip preprocessing-such as filtering, normalization, or feature extraction-before being fed into the AI model. The processing chip 314 then performs the computations to produce an output, like an anomaly score, without needing to transmit raw sensor data to the cloud.

Based on the inference output from the AI model, the chip makes on-device decisions, primarily to flag anomalies. This often involves comparing the model's output, such as an anomaly score, against a pre-defined or dynamically adjustable threshold; if the score surpasses this threshold, an anomaly is registered. This can be augmented by rule-based logic, for instance, flagging a critical anomaly if a high score persists over several readings. Beyond mere flagging, the device can be programmed for immediate local actions, like activating visual or auditory alerts, signaling other local devices, or even adjusting its own operational parameters. The anomaly detection models themselves can vary, from statistical methods like Z-scores or moving averages, to more sophisticated machine learning models such as autoencoders (which flag high reconstruction errors as anomalies), one-class SVMs (which identify data points outside a learned “normal” boundary), or isolation forests.

The direct consequence of this local processing capability is significantly faster response times to detected anomalies and ensured functionality even when cloud connectivity is intermittent or unavailable. By performing inference and initial decision-making directly on the device, the latency associated with sending data to the cloud and awaiting a response is entirely eliminated, which is critical for time-sensitive events requiring immediate awareness. Furthermore, if the connection to the cloud is temporarily lost due to network issues or remote deployment, the sensor can continue its primary function of monitoring and identifying anomalies. It can locally store records of flagged events and then transmit this batch of information once connectivity is restored, a “store-and-forward” mechanism that ensures data integrity and operational continuity. While longer-term data sharing with the cloud remains important for comprehensive trend analysis, model retraining, and system-wide insights, the immediate processing at the edge makes the overall system more robust, resilient, and responsive.

In embodiments, the processing chip 314 can be updated with new or retrained models to enhance its analytical capabilities and maintain accuracy in inferencing tasks. This update process is facilitated by the services platform system 114, which employs over-the-air (OTA) updates. OTA updates are a mechanism for deploying the latest machine learning models directly to edge devices without requiring physical access. The services platform system 114 manages the distribution of these updates, ensuring that models on the processing chip 314 remain current with the latest data and algorithmic advancements. By continuously retraining models using recent datasets, the system can adapt to dynamic operational conditions and evolving anomaly patterns, thereby boosting detection accuracy and system reliability.

This update process is facilitated by the services platform system 114, which employs over-the-air (OTA) updates. OTA updates are a critical mechanism for deploying the latest machine learning models directly to edge devices without requiring physical access. This involves using wireless communication protocols such as LoRa, Wi-Fi, LTE, or 5G, which enable high-speed and reliable data transmission essential for efficient updates. The services platform system 114 can manage the distribution of these updates through a centralized management interface, which oversees version control, deployment scheduling, and compliance with security protocols. This system uses secure data channels utilizing encryption standards such as AES-256 to ensure the integrity and confidentiality of the machine learning models during transit. To ensure that models on the processing chip 314 remain current with the latest data and algorithmic advancements, the services platform incorporates automated model selection techniques. It can evaluate and deploy different model versions based on performance metrics collected from the field, such as accuracy, inference speed, and resource consumption, optimizing for the specific conditions of each edge device environment. The services platform system 114 also supports rollback capabilities, allowing it to revert to previous model versions if the newly deployed model does not perform as expected. This is achieved through maintaining a secure repository of model versions that can be swiftly accessed when needed, thus enhancing the resilience and adaptability of the edge computing network. By integrating these capabilities, the services platform system 114 ensures that the processing chip 314 not only benefits from the most up-to-date machine learning models but also from a robust and flexible deployment infrastructure that can adapt to changing technical and operational requirements.

The OTA update mechanism provides several advantages. Firstly, it allows for seamless integration of model improvements, including optimization of their architecture or parameters, directly improving processing chip performance. Secondly, it minimizes downtime and disruption, as updates can be scheduled during low-activity periods or executed in real-time without significant interruption to device operations. Lastly, this approach supports the agile development and deployment of machine learning solutions, ensuring that the processing chip 314 is consistently equipped with state-of-the-art inferencing capabilities. Overall, by utilizing this update strategy, the system ensures robust edge computing functionality, empowering the processing chip 314 to effectively perform real-time analysis and contribute to intelligent, autonomous systems within the broader IoT ecosystem.

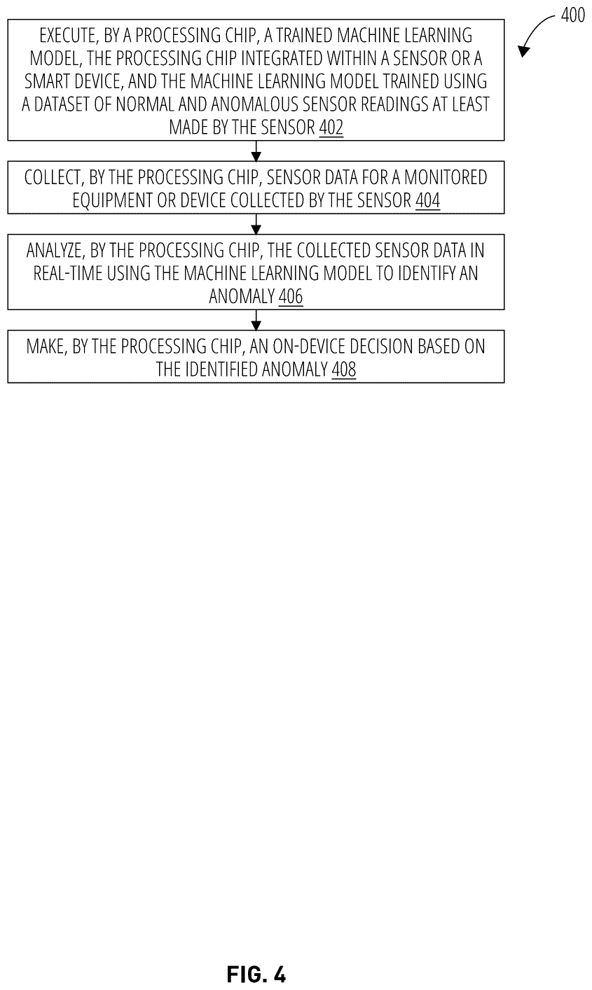

FIG. 4 illustrates an example of one or more operations that may be performed by an integrated processing chip.

In block 402, routine 400 executes, by a processing chip, a trained machine learning model, the processing chip integrated within a sensor or a smart device, and the machine learning model trained using a dataset of normal and anomalous sensor readings at least made by the sensor. This setup provides localized decision-making capabilities, enhancing the efficiency and responsiveness of automated systems across various applications. In embodiments, the processing chip may be a microcontroller or a specialized processor, designed to handle complex computations directly at the device level. By embedding the computational power within the sensor or smart device, data processing is expedited, reducing the latency associated with transmitting data to centralized servers for analysis.

The machine learning model executed by this processing chip can be trained on a substantial dataset comprising normal and anomalous sensor readings. This dataset includes historical data captured by the sensor itself, augmented with labeled instances of regular and irregular operational scenarios. The dataset may also include data from different sensors of the same type. Training involves using algorithms capable of classifying or detecting deviations, such as decision trees, support vector machines, or neural networks. The model is tuned to recognize patterns that define normal operations and to identify deviations that signal potential anomalies. Once trained, the model is embedded within the processing architecture of the sensor or smart device. This allows real-time execution, where incoming sensor data is immediately analyzed against the patterns and thresholds established during training. The model's decision-making process involves evaluating each new data point or batch of sensor readings to determine if an anomaly is present based on learned behaviors. The advantage of this localized model execution is multifold. First, it enables faster response times as anomalies are detected at the source without the need for data transmission delays. Second, it reduces the bandwidth requirements and load on central systems, since only relevant insights or detected anomalies need to be communicated upwards in the system architecture. Third, it enhances system reliability and resilience, as the localized processing continues to function even if connectivity to central systems is interrupted. In essence, this approach leverages the strengths of machine learning to augment sensor capabilities with intelligent monitoring right at the edge, promoting proactive maintenance, timely alerts, and improved operational security and efficiency.

In block 404, routine 400 collects, by the processing chip, sensor data for a monitored equipment or device collected by the sensor. In example, the processing chip collects data, it starts by interfacing directly with the sensor elements embedded in or attached to the equipment being monitored. These sensors are tailored to measure various parameters, such as temperature, pressure, vibration, humidity, or electrical characteristics, depending on the equipment type and monitoring requirements. The processing chip continuously receives raw sensor data, which often includes analog signals representing physical phenomena. These analog signals are then converted into digital form through an analog-to-digital converter (ADC) embedded within the chip, or at a proximal stage in the sensor architecture, to facilitate further processing.

Once digitized, the data is typically subjected to initial filtering and noise reduction processes, as discussed. The processing chip employs various signal processing techniques to remove extraneous interference, stabilizing the data for more accurate analysis. For example, low-pass filters can eliminate high-frequency noise, while moving average filters smooth out transient fluctuations. The processing chip can also perform preliminary data aggregation or transformation tasks, such as summarizing the data over time intervals, calculating statistical metrics like mean or variance, or converting units to standard formats. This prepares the data for further stages of analysis. Moreover, the processing chip is configured to perform timestamping of each data point, establishing a temporal context that is crucial for tracking changes over time, identifying trends, and correlating the sensor data with other time-sensitive information in the monitoring system.

In block 406, routine 400 analyzes, by the processing chip, the collected sensor data in real-time using the machine learning model to identify an anomaly. The analysis of collected sensor data in real-time using a machine learning model executed by a processing chip enhances the swift and efficient detection of anomalies. This operation integrates machine learning techniques directly at the point of data collection, leveraging edge computing for immediate insights and actions. Initially, the processing chip preprocesses the data, ensuring it is digitized and filtered for noise reduction. This clean data stream is then fed into the on-chip machine learning model, which has been trained on historical datasets encompassing both normal and anomalous operational parameters. The model, which might utilize algorithms like clustering, decision trees, or advanced neural networks such as CNNs or LSTMs, evaluates incoming data points against learned patterns to classify them as normal or anomalous. Real-time analysis on the processing chip offers several advantages. It facilitates rapid responses by triggering alerts or corrective actions immediately upon anomaly detection, minimizing potential operational impacts.

In block 408, routine 400 makes, by the processing chip, an on-device decision based on the identified anomaly. For example, the processing chip may execute a corrective action including shutting off the malfunction device, notifying a responsible entity, and/or scheduling an entity to fix the device including providing access rights. Once the processing chip identifies an anomaly through real-time analysis, it is capable of making on-device decisions to initiate immediate corrective actions. One fundamental action the processing chip can take is executing a direct control command to shut off the malfunctioning device. This action is particularly crucial in preventing further damage or safety hazards, such as in cases where a device might overheat or cause system overloads.

In addition to direct control actions, the processing chip can facilitate communication protocols to notify a responsible entity. This notification can be sent via various channels, such as email, SMS, or messaging through dedicated apps, and typically includes detailed information about the anomaly, the device affected, and potential causes. By providing this information, the maintenance team or relevant personnel can prepare more effectively for any necessary intervention.

Furthermore, the processing chip can integrate with broader facility management systems to automatically schedule a maintenance entity to address the issue. This scheduling involves interfacing with digital work order systems or sending requests through integrated management software that prioritizes the anomaly based on its severity and impact. Part of this scheduling functionality includes negotiating and granting temporary access rights, ensuring that maintenance personnel or third-party service providers can access secure areas around the malfunctioning device. This involves dynamically adjusting access permissions at the necessary access points along the path to the device, often using secure communication protocols to update access controls in real-time. By making on-device decisions, the processing chip enhances system resilience, reduces response times, and coordinates human and automated responses efficiently.

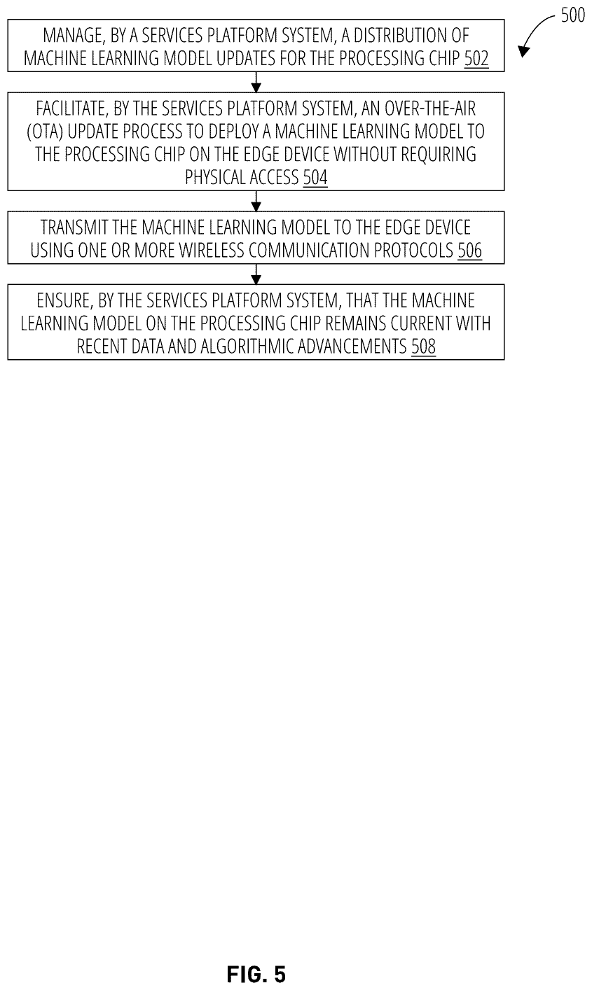

FIG. 5 illustrates an example of operations that may be performed by a services platform system to provide over-the-air updates. The services platform system manages the distribution of machine learning model updates to the processing chip through a comprehensive and automated process designed to streamline the delivery, implementation, and maintenance of updated algorithms.

In block 502, routine 500 manages, by a services platform system, a distribution of machine learning model updates for the processing chip. This system is tasked with several functions to ensure the efficient and effective dissemination of model updates. Initially, the platform consolidates different machine learning model versions within a centralized repository, which contains models optimized for various applications and processing environments, e.g., sensors and devices. This repository acts as the primary source for model retrieval during the update cycle.

In some instances, the services platform system 114 utilizes sophisticated version control mechanisms to track changes and developments in each model iteration, ensuring that the most effective version is selected for deployment. Upon determining the need for an update—whether prompted by periodic schedules, the appearance of new data patterns, or performance analytics feedback—the platform initiates a deployment process. This may involve a series of preparatory steps, including compatibility checks, which ensure that the new model can be accommodated by the hardware specifications and existing software environment of the processing chip. The platform employs secure delivery protocols for transmitting updates, utilizing encrypted communication channels to protect model data integrity and confidentiality during transfer. This is especially critical in environments where updates occur over long-range wireless networks, such as LoRa, 4G, 5G, or Wi-Fi, where the risk of interception exists. The services platform also provides orchestration capabilities, allowing for batch processing and staged rollouts of model updates. It can coordinate simultaneous updates across multiple devices, ensuring minimal disruption to ongoing operations and reducing the overall bandwidth load on the network. Advanced scheduling features allow the system to prioritize updates for critical devices or defer updates during peak operational periods to maintain system stability. Once the model is deployed to the processing chip, the platform oversees its integration and performs verification tasks to ensure the model operates as expected. Feedback mechanisms allow the platform to rapidly adjust and refine deployment strategies in response to observed outcomes. Finally, services platform system 114 maintains comprehensive logs of all update activities. These logs serve as valuable documentation for auditing and compliance purposes, offering insights into update history and the evolution of model improvements over time. By orchestrating these tasks, the services platform plays a crucial role in maintaining the efficacy and relevance of machine learning models within dynamic operational environments.

In block 504, routine 500 facilitates, by the services platform system, an over-the-air (OTA) update process to deploy a machine learning model to the processing chip on the edge device without requiring physical access. The services platform system plays an essential role in facilitating the over-the-air (OTA) update process, enabling the deployment of machine learning models to processing chips on edge devices without the necessity for physical access.

The OTA process begins with the services platform system 114 identifying the need for model deployment or updates. This determination can be prompted by several factors, including the availability of a new model version, security patches, or performance enhancements based on recent operational data and analytics. Once the decision to update is made, the system prepares the model for distribution.

The preparation phase involves packaging the machine learning model and any accompanying metadata, such as version information and compatibility requirements. This package is then secured using encryption protocols that ensure both the integrity and confidentiality of the transmitted data. Standard encryption techniques like Advanced Encryption Standard (AES) or Transport Layer Security (TLS) are used to protect the model as it traverses potentially insecure networks.

The services platform system 114 then utilizes wireless communication technologies to deliver the update to the edge device. These technologies may include cellular networks such as 4G and 5G, or local wireless networks like Wi-Fi. The choice of communication protocol depends on the connectivity options available at the device's location and the desired speed and reliability of the update process.

Throughout the OTA process, the platform system manages and coordinates the update deployment across multiple devices, ensuring that network resources are optimally utilized. This includes scheduling updates during periods of low network traffic to minimize disruption and employing bandwidth-efficient methods such as delta updates, which only transmit changes rather than the entire model file.

Once the machine learning model reaches the processing chip on the edge device, the platform oversees its installation and integration. It performs checks to confirm that the model operates correctly within the device's computational environment and adheres to predetermined performance benchmarks. The system may also initiate a verification procedure to ensure that the update does not compromise device functionality or security.

Finally, the services platform system monitors post-update performance, collecting telemetry data and user feedback to assess the impact of the new model deployment. This information is crucial for continuous improvement cycles, allowing the system to refine future update processes and enhance model performance incrementally.

In block 506, routine 500 transmits the machine learning model to the edge device using one or more wireless communication protocols. This process involves several sophisticated steps and technologies to achieve reliable and swift data transmission. First, the model is prepared for transmission by packaging it with relevant metadata, such as compatibility information and version number, which are crucial for ensuring proper integration into the existing system architecture on the edge device. This preparation phase may also involve compressing the model to reduce file size, thereby lowering transmission time and conserving bandwidth.

The services platform system selects appropriate wireless communication protocols based on several factors, including the location of the edge device, available network types, and the specific requirements for speed and reliability of the model update. Common wireless communication protocols include LoRa or Wi-Fi, which is widely used for its robust and high-speed data capacity; Bluetooth, for short-range, lower power updates; and cellular networks such as LTE and 5G, which provide extensive range and fast data transmission capabilities.

The system employs encryption techniques, such as AES-256 or TLS, to secure the machine learning model during transmission, ensuring that the data is neither intercepted nor tampered with. This is particularly important for maintaining the integrity of the update process and safeguarding sensitive information. As the model is transmitted over the chosen network, the services platform system 114 monitors the process for any disruptions or anomalies. In the event of a transmission failure or data corruption, the system can automatically initiate retransmission, thus guaranteeing that the complete and correct model version reaches the edge device. After successful transmission, the edge device receives the model package, which triggers the installation and integration phase.

The services platform system 114 verifies the integrity of the received model using digital signatures or checksums, ensuring that what is installed is identical to the original version. Only after passing these checks does the model become operational on the device, ready to enhance the edge device's computational capabilities with the latest algorithmic advancements.

In block 508, routine 500 ensures, by the services platform system, that the machine learning model on the processing chip remains current with recent data and algorithmic advancements.

The services platform system plays a vital role in maintaining the currency of the machine learning model on the processing chip by systematically integrating recent data and algorithmic advancements. This task involves a multifaceted approach to ensure the model's performance and accuracy are consistently optimized in response to evolving conditions and technological developments. To begin with, the services platform 114 constantly monitors data streams and operational environments from the edge device to gather real-time information about system performance and external conditions. This monitoring allows the platform to identify changes or trends that might require model updates. The services platform system 114 uses this data to inform retraining processes, ensuring that models are adjusted to reflect new patterns or behaviors. The retraining process typically occurs in a centralized computing environment where computational resources are more abundant. By leveraging large datasets that include a mix of historical and newly acquired data, the platform can refine the machine learning model's ability to accurately predict outcomes and detect anomalies. Advanced techniques, such as transfer learning and continual learning, are employed to incorporate new experiences into the model without compromising its existing knowledge. Algorithmic advancements are also a part of keeping the model current.

The services platform system 114 continuously evaluates the latest developments in machine learning algorithms, leveraging research and development insights to enhance model architectures and methodologies. This might involve adopting new algorithms that offer improved efficiency, scalability, or precision, allowing for more effective inferencing on the processing chip. Once models are updated with new data and algorithms, the services platform ensures they are distributed to the edge devices through secure and efficient channels, often using over-the-air updates. These updates are managed to minimize disruption, scheduling them during low-demand periods or utilizing incremental update strategies to reduce the data overhead. In addition to these processes, the platform conducts regular performance evaluations post-deployment to validate that the updates have achieved the desired improvements. This involves comparing the model's predictive accuracy and processing metrics against predefined benchmarks. If any discrepancies are identified, the platform can quickly iterate new updates or revert to previous stable versions. Moreover, the platform employs feedback loops that continuously collect performance data from the edge devices, providing insights into how models perform in diverse and dynamic situations. This feedback is crucial for identifying further optimizations and ensuring ongoing alignment with organizational goals and industry standards.

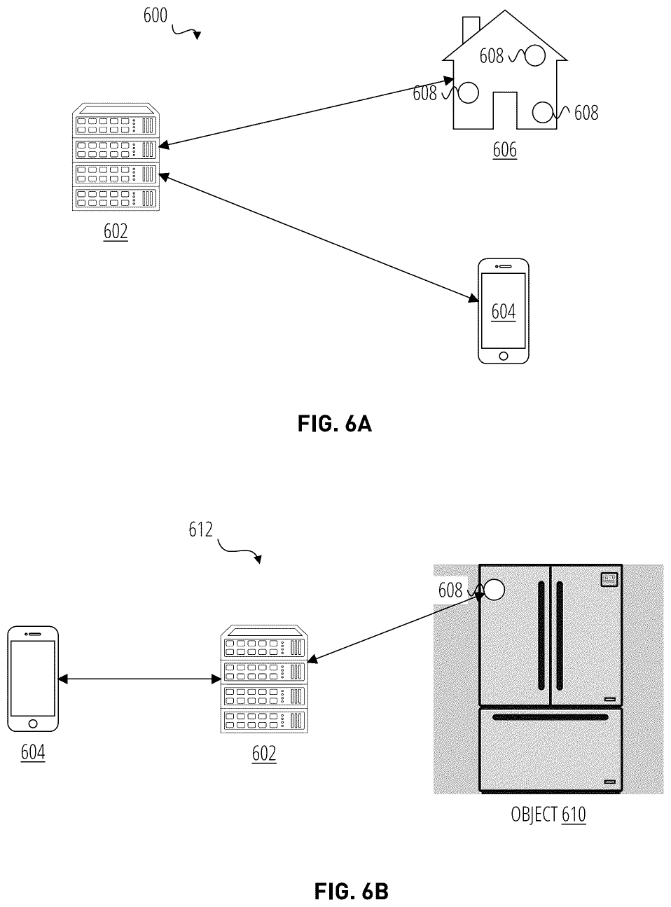

FIG. 6A illustrates another example embodiment of a system 600. In one example, the system 600 may augment or be part of the smart building system 100, such as the services platform system 114 and sensor system 106, or may be a stand-alone system to identify anomalies via sensors and interact with other systems of the services platform system 114 to provide a resolution. The system 600 includes a modeling system 602 that processes and analyzes data obtained from sophisticated sensors, such as sensor 608. The sensor 608 is capable of detecting a wide range of physical phenomena, such as motion, sound, temperature, light, pressure, and humidity among others. In embodiments, sensor 608 may the similar to or the same as sensor 108.

Once a sensor 608 captures data related to these phenomena, modeling system 602 performs a variety of functions. The modeling system 602 is capable of interpreting the raw data to understand the characteristics of the environment or object being monitored. For example, the modeling system 602 can identify whether a room is occupied based on motion and sound data, or assess the comfort level of a space by analyzing temperature and humidity data. In another example and as previously discussed, the sensor 608 can be affixed to an object, such as an appliance, and detect characteristics of the object, e.g., when the object is running, in an idle state, operating temperature of a device, etc.

In some instances, the modeling system 602 applies advanced algorithms and machine learning models to analyze the data further. This analysis can reveal patterns, trends, and anomalies within the data. For instance, the modeling system 602 could detect gradual increases in temperature that suggest overheating of a device or predict potential failures in a system by noticing subtle changes over time, e.g., more and more motion and vibrations.

Moreover, the modeling system 602 is configured to make predictions based on the analyzed data. By learning from historical data, the modeling system 602 can forecast future conditions, behaviors, or events. For example, the modeling system 602 predicts when a room will likely be occupied based on past motion and sound patterns and provides this information to users via user devices 604. In one example, the modeling system 602 generates an occupancy heat map to illustrate predicted and/or actual occupancy patterns of a room or space.

Additionally, the modeling system 602 can provide actionable insights and recommendations to users or other systems of the services platform system 114. It could alert users to unusual conditions that need attention or automatically adjust systems to maintain optimal conditions based on the predictions made. Further, the modeling system 602 may provide a inference result indicating anomaly to the maintenance system 110 and access control system 112 such that the services platform system 114 performs an automated response.

The integration of this AI system with sensors 608 capable of detecting a diverse array of physical phenomena furnishes a robust tool for monitoring, analysis, and predictive management in a myriad of applications ranging from smart buildings and industrial monitoring to environmental observations and healthcare. In embodiments, the sensor 608 is a device that detects or measures physical properties and records, indicates, or otherwise responds to physical or chemical changes in an environment. In some instances, the sensor 608 converts physical phenomena such as temperature, pressure, light, or motion into electrical signals or other forms of output that can be measured and analyzed. A sensor 608 may include one or more components, such as sensing element for the direct conversion of a physical phenomenon (such as temperature, humidity, pressure, light, etc.) into a measurable signal. In embodiments, the sensing element's material and design are tailored to respond to specific stimuli. The sensor 608 may also have a transducer that converts the physical signal detected by the sensing element into an electrical signal. In some instances, a sensor 608 can have integrated transducers, whereas in others, the transducer functions as part of the sensing element. The sensor 608 may also have signaling circuitry that processes the electrical signal from the transducer to make it suitable for reading. The circuitry may perform processing including amplification, filtering, converting, or any other modifications of the signal.

Other components, of the sensor 608 may include a power supply, such as a battery or direct connection to an external power source, and a housing that protects the sensor's internal components from environmental conditions, mechanical stress, and other factors that could potentially damage the sensor. The housing can also influence how the sensor interacts with its environment, ensuring accurate measurements. In some instances, the sensor 608 may be a smart sensor and have more complex hardware, such as a processor that can perform more complex tasks such as data analysis, storage, and communication with other devices through built-in networking capabilities, a communication interface, that enables the sensor 608 to send data to and receive commands from external systems or networks. This interface can be wired (e.g., Ethernet, USB) or wireless (e.g., Wi-Fi, Bluetooth). These components together allow the sensors 608 to accurately and reliably detect and measure a wide range of physical conditions, converting the observed phenomena into useful data for analysis, monitoring, and control systems.

In embodiments, a sensor 608 may be coupled or linked with the modeling system 602 via the wired or wireless interface(s) to communicate data to the modeling system 602. The modeling system 602 may provide a sensor communication layer, such as a set of application programming interface(s) (APIs) that enable sensors sensor 608 to send the data to the modeling system 602. In some instances, the modeling system 602 may be configured for using standardized protocols (e.g., MQTT, REST) to receive data or custom drivers. The communication layer enables continuous or event-triggered data transmission from a sensor 608 to the modeling system 602.

In embodiments, the modeling system 602 receives and stores data from one or more sensors 608 to train a model. The modeling system 602 may include a data management layer configured to store the data and information about each sensor 608 (type, location, calibration data, etc., to process the data and perform model training, the modeling system 602 may include a data processing layer. In one example, the modeling system 602 including the data processing layer may perform data preprocessing, such as data cleaning that filters out noise, outliers, or erroneous readings from raw sensor data, feature extraction that transforms raw data into meaningful features (e.g., peak vibration frequencies, average motion, light intensity trends). The modeling system 602, including the data processing layer, may perform data fusion that combines data from multiple sensors to create a richer, multi-dimensional view of the physical environment. In other instances, the model may be trained on data from a single sensor 608.

In embodiments, the modeling system 602 also includes a modeling engine that trains on the data and generates a model. The modeling system 602 utilizes a variety of techniques (e.g., regression, classification, clustering, anomaly detection) to identify patterns, trends, and anomalies in the sensor data. The modeling system 602 including the modeling engine incorporates domain-specific knowledge (e.g., laws of physics, material properties) to enhance the accuracy and interpretability of the models. In embodiments, the modeling system 602 also includes adaptive learning that continuously refines the models based on new data and changing environmental conditions.

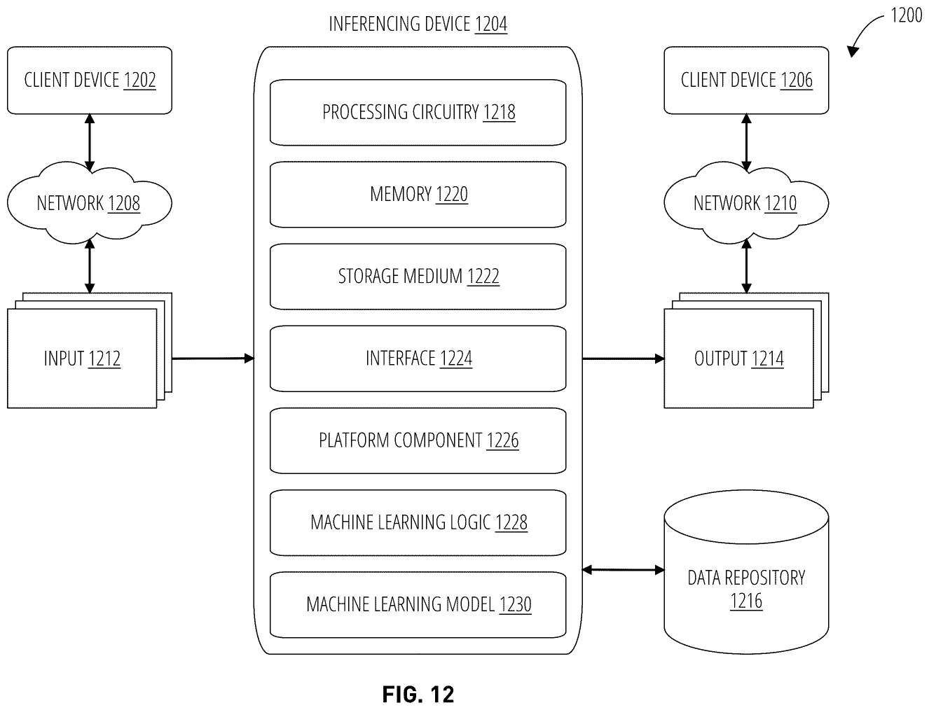

In embodiments, the modeling system 602 also includes an output layer that provides outputs based on the data processing. For example, the modeling system 602 provides interactive visualizations of sensor data, model predictions, and derived insights. The modeling system 602 also triggers alarms or sends notifications when pre-defined thresholds or conditions are met (e.g., abnormal vibration levels, sudden temperature spikes, etc.). The modeling system 602 also generates detailed reports and logs for historical analysis and compliance purposes. Additional details with respect to the modeling system 602 are discussed with regard to FIG. 12 through FIG. 15 and corresponding text.

FIG. 6A illustrates one configuration of system 600 in which sensors 608 are placed in one or more locations of a structure. In this example configuration, the sensors 608 may detect occupancy and other characteristics of a particular space or location within a structure, such as an apartment building or house. System 600, including the modeling system 602, may train on the data collected by the sensors 608, generate a model, and provide predictions on the characteristics of the space as discussed above. The predictions can be provided to the user via a user device 604 and displayed on a display device, e.g., in a mobile application.

FIG. 6B illustrates another configuration of system 612 in which a sensor 608 is affixed, associated with, and/or coupled to an object, such as an appliance. In this example, the sensor 608 may detect characteristics of the object or appliance, such as motion, vibration, noise, and temperature. Similarly, the modeling system 602 may collect data from the sensor 608, generate a model, and generate predictions, as discussed above. In this example, the modeling system 602 may provide the predictions for the object to the user device 604.

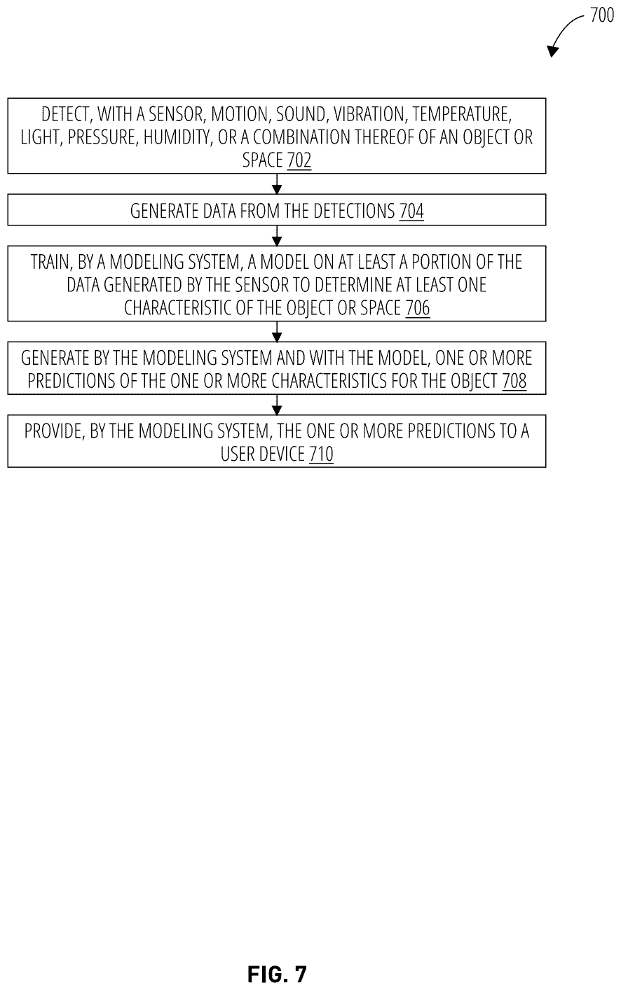

FIG. 7 illustrates one example routine 700 in accordance with embodiments discussed herein to train on data and generate a model to provide physical phenomenon predictions. In embodiments, one or more operations discussed in FIG. 7 may be performed by a system, such as a system 600 and/or system 612.

In block 702, routine 700 includes detecting, by a sensor, one or more Physical phenomena of an object or a space referring to natural occurrences or processes that can be observed and measured in the physical universe, e.g., by a sensor. Examples include electromagnetic radiation, gravitational forces, thermodynamics, fluid dynamics, motion, sound, vibration, temperature, light, pressure, humidity, etc.

In block 704, routine 700 includes generating data from the detections. Specifically, the sensor may measure the physical phenomena. The sensor, as described above, detects and records specific physical phenomena occurring in an environment. This capability enables the sensor to gather quantitative data on these occurrences, which might include variables such as temperature changes, light intensity, electromagnetic fields, motion, pressure variations, or other environmental conditions that can be precisely measured. The sensor translates these physical inputs into electrical signals or data that can be analyzed and interpreted. This process allows for the monitoring, recording, and understanding of a space or an object.

In block 706, routine 700 includes training, by a modeling system, a model on at least a portion of the data generated by the sensor to determine at least one characteristic of the object or space. Specifically, the modeling system utilizes at least a portion of data collected by the sensor to train a model. The primary aim of this training is to enable the model to identify or predict at least one specific characteristic of an object or a space inherent within the data. The process involves applying algorithmic or statistical techniques to discern patterns, correlations, or trends in the sensor-generated data that are relevant to the characteristic(s).

For example and in block 708, the routine 700 includes generating by the modeling system and with the model, one or more predictions of the one or more characteristics for the object or the space. Specifically, the modeling system, which is equipped with the trained model, is now capable of generating predictions regarding one or more characteristics of a specific object or space. Utilizing the underlying patterns, trends, and correlations discovered during the model's training phase, the modeling system produces predictions about the characteristics it has learned to identify or estimate characteristics of the space or object. These predictions can encompass a wide range of attributes, such as physical properties, behavioral tendencies, or changes over time, depending on the nature of the object or space and the scope of the model's training.

In block 710, the routine 700 includes providing the one or more predictions to a user device by the modeling system. Specifically, the modeling system communicates the predictions generated by the modeling system to a user device. After the modeling system, using the trained model, computes predictions concerning the characteristics of an object or a space, these insights are then transmitted to a device utilized by the end-user. The user device could be a smartphone, computer, tablet, or any other form of technology capable of receiving and displaying data. The transmission of information can occur over various communication networks, including wired connections, wireless networks (such as Wi-Fi or cellular networks), or the Internet. By delivering these predictions to the user device, the system facilitates immediate access to the predictive insights, enabling users to make informed decisions, monitor conditions, or undertake further analysis based on the characteristics predicted by the model.

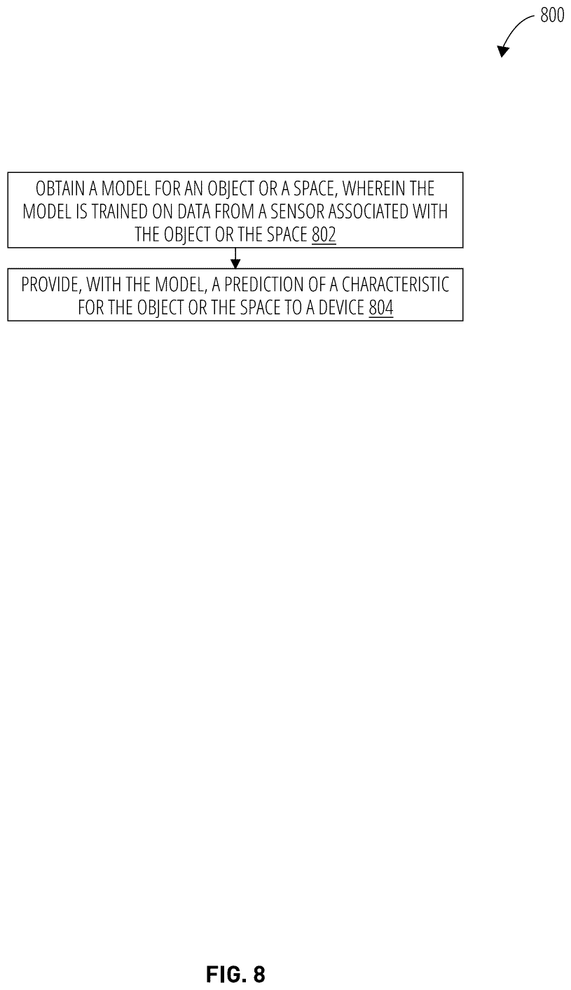

FIG. 8 illustrates an additional example of a routine 800 in accordance with the embodiments discussed herein. In embodiments, the operations discussed in routine 800 may be performed by a modeling system 602 or another/different system, such as a server that has obtained the trained model from the modeling system 602. In some instances, the operations of routine 800 may be performed by the user device, embodiments are limited in this manner.

In block 802, routine 800 includes obtaining a model for an object or a space, wherein the model is trained on data from a sensor associated with the object or the space. For example, a server or user device may receive or retrieve a model trained by a modeling system to determine predictions made about the characteristics of the space or object. The process involves acquiring a model tailored to analyze or predict characteristics of an object or space, using a model that has been trained using data collected by a sensor linked to that object or space. This approach leverages the empirical data from the sensor to inform the model's training, enabling it to accurately interpret or anticipate the specific conditions, behaviors, or properties of the object or space in question.

In block 804, the routine 800 includes providing, with the model, a prediction of a characteristic for the object or the space to a device. This step entails delivering a prediction generated by the model about a characteristic of the object or space, directly to a user's device. The model, having been trained on sensor data associated with the object or space, uses its analytical capability to forecast a specific attribute or condition. This forecast or prediction is then transmitted to a device, such as a smartphone, computer, or specialized equipment, enabling the user to receive insightful information digitally. The process bridges the gap between sophisticated data analysis and practical, actionable insights, thereby facilitating informed decision-making, monitoring, or further analysis by the user based on the predicted characteristics of the object or space.

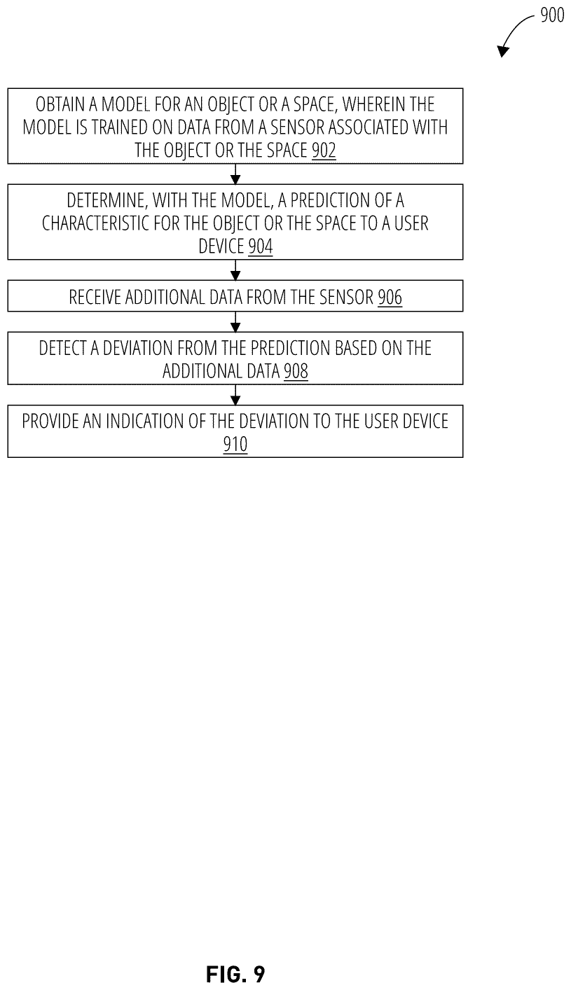

FIG. 9 illustrates another example of a routine 900 that may be performed in accordance with the embodiments discussed herein. routine 900 is similar to routine 800; however, a device or server may utilize real-time or additional data to detect a deviation from a prediction.

In block 902, the routine 900 includes obtaining a model for an object or a space, wherein the model is trained on data from a sensor associated with the object or the space, and in block 904, routine 900 includes determining, with the model, a prediction of a characteristic for the object or the space to a user device.

In block 906, the routine 900 includes receiving additional data from the sensor. The data may be real-time data or other data received subsequent to the data used for training and obtained by the sensor.

In block 908, the routine 900 includes detecting a deviation from the prediction based on the additional data. For example, the system continues to analyze new, additional data related to that object or space. As this fresh data is assessed, the system employs the pre-established model to evaluate whether the actual observed characteristics deviate from what was previously predicted. This comparison between the model's prediction and the real-time data allows for the identification of discrepancies, anomalies, or changes that weren't anticipated in the initial forecast. Detection of such deviations is crucial for adaptive learning, real-time monitoring, and possibly triggering alerts or adjustments in response strategies, ensuring that the system remains accurate and responsive to evolving conditions.

In block 910, the routine 900 includes providing an indication of the deviation to the user device. This step involves communicating the identified deviation between the predicted characteristic and the actual data observed to a user's device. Upon detecting a discrepancy based on the additional data gathered after the initial prediction, the system actively notifies the user by sending an alert or indication to their device. This device could range from a smartphone, tablet, computer, or any system capable of receiving and displaying notifications.

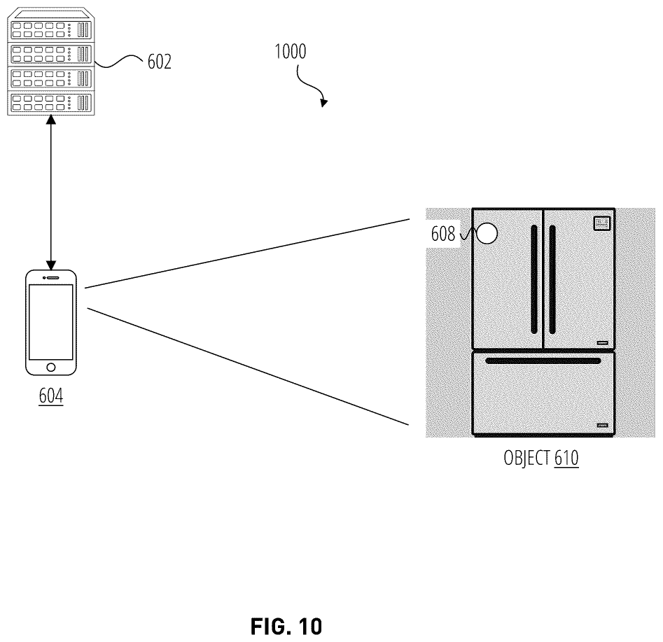

FIG. 10 illustrates another example of a system 1000 in accordance with the embodiments discussed herein. System 1000 may use the same as or similar systems 600 and 612. System 1000 illustrates the configuration or setup process that may be performed to add a sensor to an object (or space). In the illustrated example, the sensor 608 is placed on an appliance, and the end user may utilize their user device, including a mobile application, to associate the sensor with the object. Thus, once associated with the object, the system 1000 knows that sensor 608 is taking measurements that apply to the object and reports out accordingly.

In one example, a user device is configured to acquire a digital image depicting an object to which a sensor is mounted or attached. In this context, the user device employs its imaging capabilities, e.g., integrated camera, to take a picture of an object that has a sensor attached to or integrated within it. The sensor affixed to the object is designed to measure or monitor specific parameters or conditions related to the object, such as temperature, pressure, movement, or physical phenomena. When the user device captures an image of this object, it visually documents not only the physical appearance of the object but also the presence and position of the sensor. This action can serve multiple purposes, such as providing evidence of the sensor's installation and associating the sensor with the object.

In another example, the user device enables a user to enter the information about the object via an input interface. The user device is equipped with an input interface, designed to enable users to input various types of information pertaining to an object. This interface may support multiple forms of data entry, including but not limited to, text input, voice commands, or digital file uploads, allowing for a comprehensive and user-friendly method of communicating details about the object directly into the system. This capability ensures that users can accurately and efficiently update or input data, thereby enhancing the device's utility in managing, tracking, or analyzing the object in question. The user device enables the user to enter a wide range of information of the object, including but not limited to, physical characteristics (such as size, shape, color, and material composition), operational data (like usage patterns, performance metrics, and energy consumption), as well as other qualitative and quantitative attributes, location of object, etc.

In addition, the user device employs object detection algorithms to accurately identify the designated object. Specifically, the user device leverages sophisticated object detection algorithms to pinpoint and recognize the specific object of interest within its field of view. These algorithms analyze the digital image data captured by the device, applying machine learning or computer vision techniques to discern and classify various elements within the image. The device can accurately distinguish the designated object from its surrounding environment by examining patterns, shapes, colors, and other distinctive features. This capability facilitates a range of applications, including automated inventory management when adding the object an monitoring list.

In embodiments, the user device and/or system may utilize the image to identify the object and determine a baseline operation for the particular object so that the sensor can catch irregularities. For example, if the sensor is attached to an oven, heat detection will not trip an alert. But if it were on a fridge, heat detection would trigger an alert. So it knows immediately what should be considered an alert based on the image and without collecting much baseline sensor data to establish normal operation conditions. The baseline operation may be determined based on historical data, e.g., analysis of previously collected data attached to the same or similar appliance.

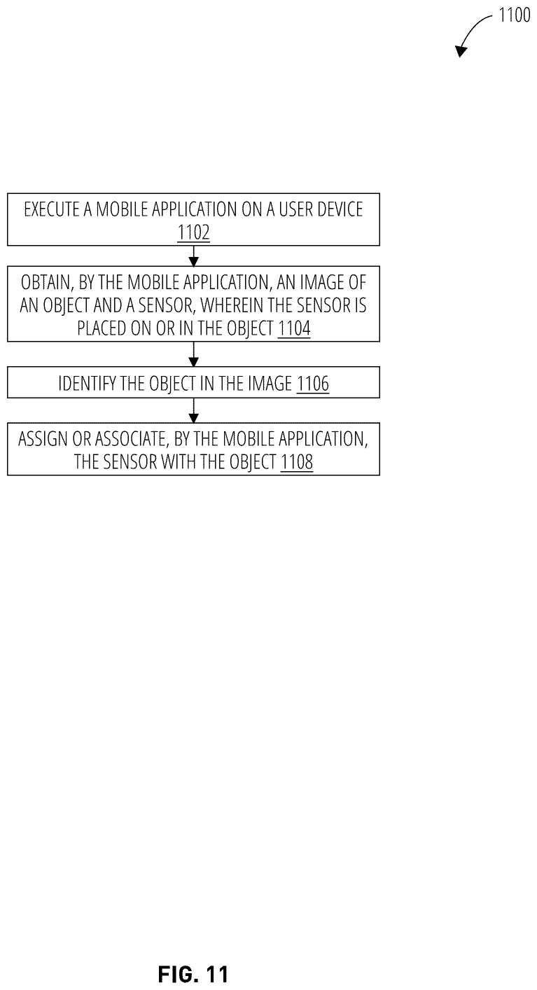

FIG. 11 illustrates an example of a routine 1100 in accordance with embodiments. Routine 1100 may be performed by one or more systems or devices discussed herein, such as a user device when performing a configuration or setup process to add a sensor to an object and the system.

In block 1102, the routine 1100 includes executing a mobile application on a user device. Running a mobile application on a user device involves initiating and operating a software application specifically designed for mobile platforms such as smartphones or tablets. In some instances, the process begins when the device receives a selection or command to open the application, causing the device's operating system to allocate the necessary resources and launch the app. Once executed, the mobile application typically provides a user interface through which the user can interact, allowing access to its functionalities and services. This operation can encompass a wide range of activities, from accessing information, performing tasks, and engaging in communication to controlling connected devices or systems, all designed to enhance or facilitate the user's experience and objectives with the application's targeted features and capabilities. In one specific example, the mobile device enables a user to add a sensor to a system and associate the sensor with an object for which it is monitoring.

In block 1104, the routine 1100 includes obtaining, by the mobile application, an image of an object and a sensor, wherein the sensor is placed on or in the object. The mobile application acquires an image featuring both an object and a sensor, where the sensor is strategically positioned either on the surface of or embedded within the object. This acquisition process is facilitated through the use of the mobile device's camera functionality, which is activated and controlled by the application. Upon capturing the image, the application processes and stores it, allowing for subsequent analysis or use within the app's functionalities.

In block 1106, the routine 1100 includes identifying the object in the image. As previously discussed, identifying the object in the image involves the mobile application employing image recognition or object detection algorithms to analyze the visual content captured within the photograph. Through this process, the application examines various features such as shapes, colors, textures, and patterns present in the image to differentiate and recognize the specific object. Advanced computational techniques, including machine learning models that have been trained on vast datasets of annotated images, enable the application to accurately classify the object and distinguish it from its background or other items within the same scene.

In block 1108, the routine 1100 including assigning or associating, by the mobile application, the sensor with the object. The process of assigning or associating the sensor with the object by the mobile application involves logically linking the sensor to the identified object within the application's framework. Once the object is identified in the image, the application proceeds to recognize the sensor either through direct image analysis or metadata associated with the image that indicates the presence and type of sensor on or in the object. This association between the sensor and the object is then recorded within the application's data structures or databases, establishing a relational link that enables the application to monitor, collect, and analyze data from the sensor specifically in the context of the object it is associated with. It allows for a targeted approach in managing and interpreting sensor data, ensuring that insights derived from the sensor are accurately applied to enhance understanding, decision-making, or actions related to the object.

FIG. 12 illustrates an embodiment of a system 1200. The system 1200 is suitable for implementing one or more embodiments as described herein. In one embodiment, for example, the system 1200 is an AI/ML system suitable for processing sensor data to provide predictions on characteristics and measurements detected by one or more sensors.

The system 1200 comprises a set of M devices, where M is any positive integer. FIG. 12 depicts three devices (M=3), including a client device 1202, an inferencing device 1204, and a client device 1206. The inferencing device 1204 communicates information with the client device 1202 and the client device 1206 over a network 1208 and a network 1210, respectively. The information may include input 1212 from the client device 1202 and output 1214 to the client device 1206, or vice-versa. In one alternative, the input 1212 and the output 1214 are communicated between the same client device 1202 or client device 1206. In another alternative, the input 1212 and the output 1214 are stored in a data repository 1216. In yet another alternative, the input 1212 and the output 1214 are communicated via a platform component 1226 of the inferencing device 1204, such as an input/output (I/O) device (e.g., a touchscreen, a microphone, a speaker, etc.).

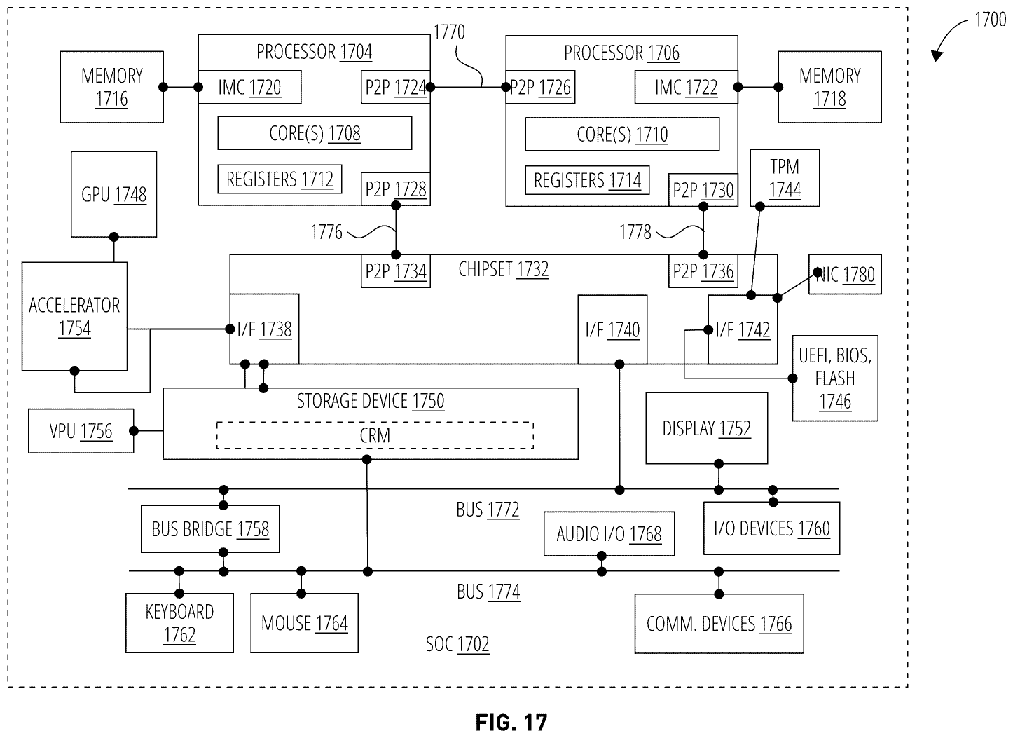

As depicted in FIG. 12, the inferencing device 1204 includes processing circuitry 1218, a memory 1220, a storage medium 1222, an interface 1224, a platform component 1226, ML logic 1228, and an ML model 1230. In some implementations, the inferencing device 1204 includes other components or devices as well. Examples for software elements and hardware elements of the inferencing device 1204 are described in more detail with reference to a computing architecture 1700 as depicted in FIG. 17. Embodiments are not limited to these examples.

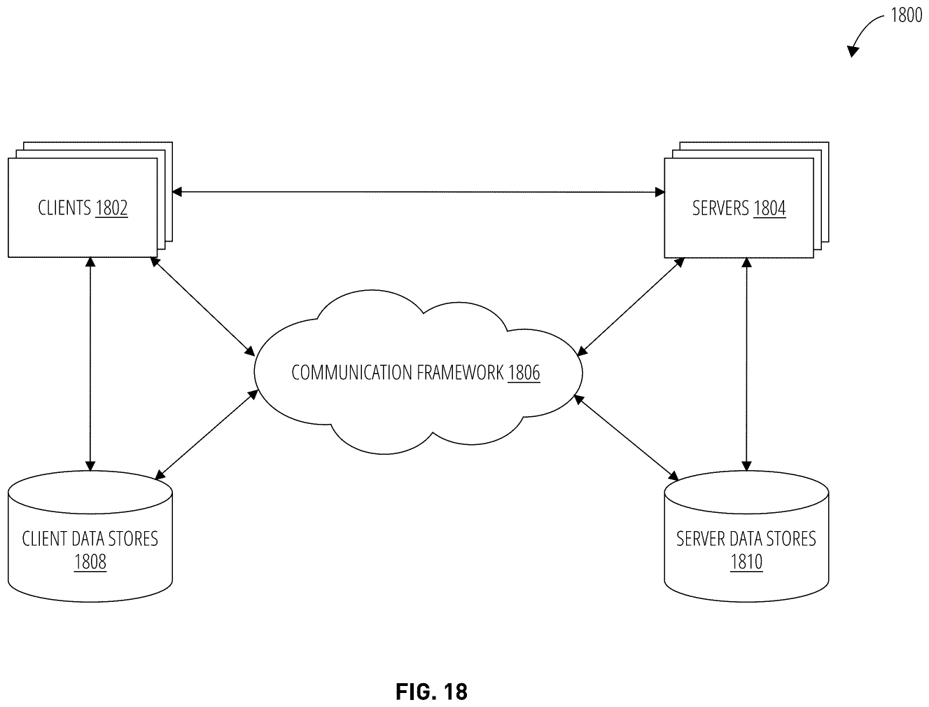

The inferencing device 1204 is generally arranged to receive an input 1212 (sensor data), process the input 1212 via one or more AI/ML techniques, and send an output 1214. The inferencing device 1204 receives the input 1212 from the client device 1202 via the network 1208, the client device 1206 via the network 1210, the platform component 1226 (e.g., a touchscreen as a text command or microphone as a voice command), the memory 1220, the storage medium 1222 or the data repository 1216. The inferencing device 1204 sends the output 1214 to the client device 1202 via the network 1208, the client device 1206 via the network 1210, the platform component 1226 (e.g., a touchscreen to present text, graphic or video information or speaker to reproduce audio information), the memory 1220, the storage medium 1222 or the data repository 1216. Examples for the software elements and hardware elements of the network 1208 and the network 1210 are described in more detail with reference to a communications architecture 1800 as depicted in FIG. 18. Embodiments are not limited to these examples.

The inferencing device 1204 includes ML logic 1228 and an ML model 1230 to implement various AI/ML techniques for various AI/ML tasks. The ML logic 1228 receives the input 1212, and processes the input 1212 using the ML model 1230. The ML model 1230 performs inferencing operations to generate an inference for a specific task from the input 1212. In some cases, the inference is part of the output 1214. The output 1214 is used by the client device 1202, the inferencing device 1204, or the client device 1206 to perform subsequent actions in response to the output 1214.

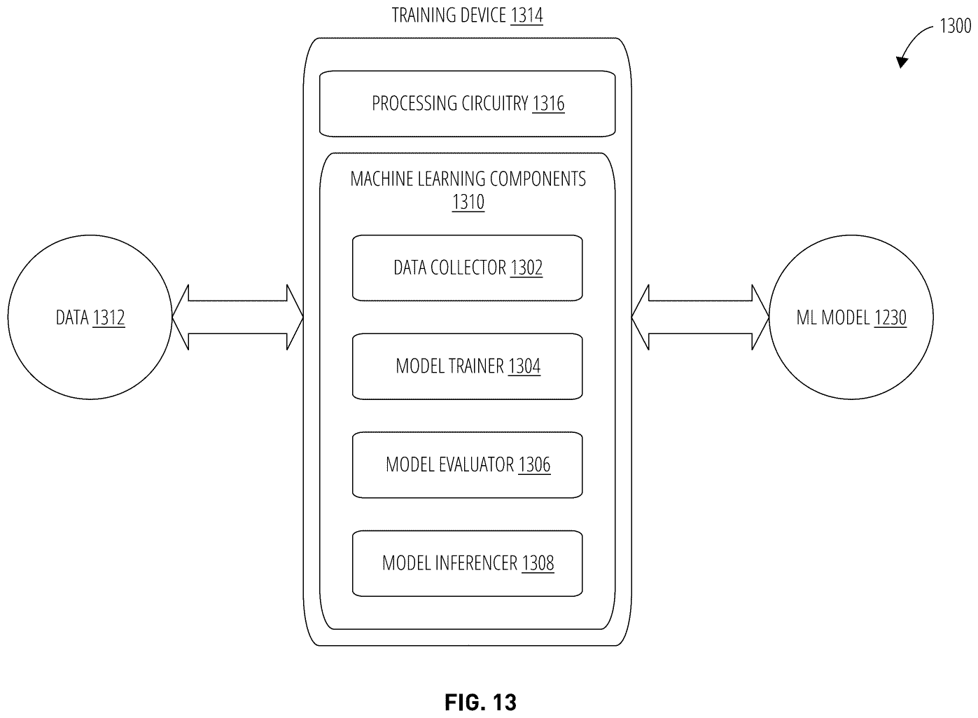

In various embodiments, the ML model 1230 is a trained ML model 1230 using a set of training operations. An example of training operations to train the ML model 1230 is described with reference to FIG. 13.

FIG. 13 illustrates an apparatus 1300. The apparatus 1300 depicts a training device 1314 suitable to generate a trained ML model 1230 for the inferencing device 1204 of the system 1200. As depicted in FIG. 13, the training device 1314 includes a processing circuitry 1316 and a set of ML components 1310 to support various AI/ML techniques, such as a data collector 1302, a model trainer 1304, a model evaluator 1306 and a model inferencer 1308.

In general, the data collector 1302 collects data 1312 from one or more data sources, such as sensors sensor 608, to use as training data for the ML model 1230. The data collector 1302 collects different types of data 1312, such as text information, audio information, image information, video information, graphic information, sensor data, and so forth. The model trainer 1304 receives as input the collected data and uses a portion of the collected data as test data for an AI/ML algorithm to train the ML model 1230. The model evaluator 1306 evaluates and improves the trained ML model 1230 using a portion of the collected data as test data to test the ML model 1230. The model evaluator 1306 also uses feedback information from the deployed ML model 1230. The model inferencer 1308 implements the trained ML model 1230 to receive as input new unseen data, generate one or more inferences on the new data, and output a result such as an alert, a recommendation or other post-solution activity.

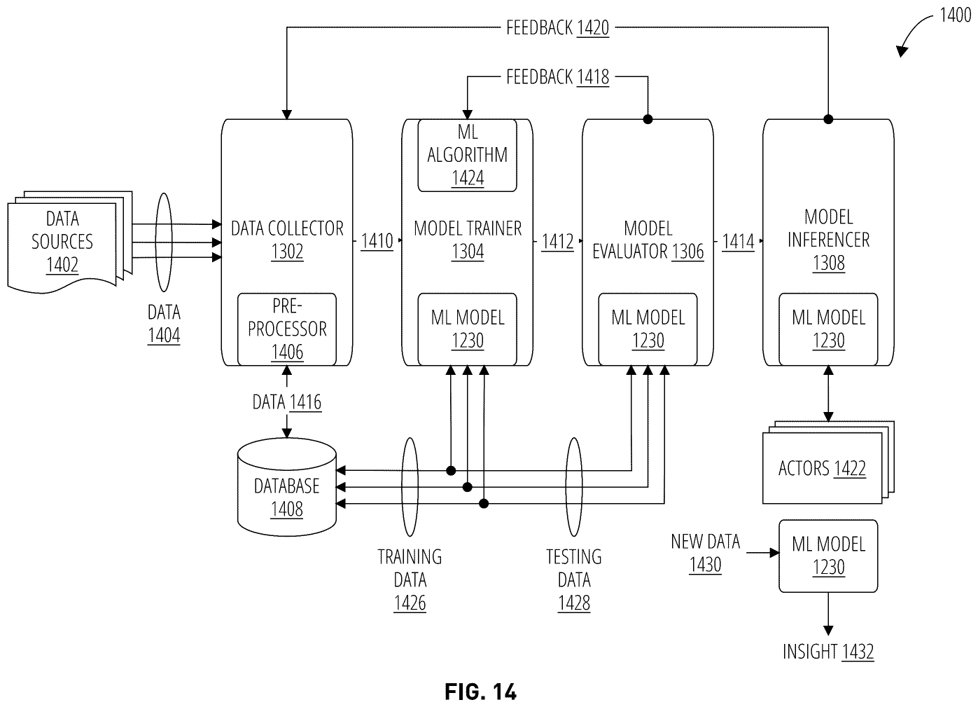

An exemplary AI/ML architecture for the ML components 1310 is described in more detail with reference to FIG. 14.

FIG. 14 illustrates an artificial intelligence architecture 1400 suitable for use by the training device 1314 to generate the ML model 1230 for deployment by the inferencing device 1204. The artificial intelligence architecture 1400 is an example of a system suitable for implementing various AI techniques and/or ML techniques to perform various inferencing tasks on behalf of the various devices of the system 1200.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1400 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1230, evaluate performance of the trained ML model 1230, and deploy the tested ML model 1230 as the trained ML model 1230 in a production environment, and continuously monitor and maintain it.

The ML model 1230 is a mathematical construct used to predict outcomes based on a set of input data, e.g., sensor data. In one example, the ML model 1230 is trained using large volumes of training data 1426, and it can recognize patterns and trends in the training data 1426 to make accurate predictions. The ML model 1230 is derived from an ML algorithm 1424 (e.g., a neural network, decision tree, support vector machine, etc.). A data set is fed into the ML algorithm 1424 which trains an ML model 1230 to “learn” a function that produces mappings between a set of inputs and a set of outputs with a reasonably high accuracy. Given a sufficiently large enough set of inputs and outputs, the ML algorithm 1424 finds the function for a given task. This function may even be able to produce the correct output for input that it has not seen during training. A data scientist prepares the mappings, selects and tunes the ML algorithm 1424, and evaluates the resulting model performance. Once the ML logic 1228 is sufficiently accurate on test data, it can be deployed for production use.

The ML algorithm 1424 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1424 of the artificial intelligence architecture 1400 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 14, the artificial intelligence architecture 1400 includes a set of data sources 1402 to source data 1404 for the artificial intelligence architecture 1400. Data sources 1402 may comprise any device capable generating, processing, storing or managing data 1404 suitable for a ML system. Examples of data sources 1402 include without limitation databases, web scraping, sensors and Internet of Things (IoT) devices, image and video cameras, audio devices, text generators, publicly available databases, private databases, and many other data sources 1402. The data sources 1402 may be remote from the artificial intelligence architecture 1400 and accessed via a network, local to the artificial intelligence architecture 1400 an accessed via a network interface, or may be a combination of local and remote data sources 1402.

The data sources 1402 source difference types of data 1404. By way of example and not limitation, the data 1404 includes structured data from relational databases, such as customer profiles, transaction histories, or product inventories. The data 1404 includes unstructured data from websites such as customer reviews, news articles, social media posts, or product specifications. The data 1404 includes data from temperature sensors, motion detectors, and smart home appliances. The data 1404 includes image data from medical images, security footage, or satellite images. The data 1404 includes audio data from speech recognition, music recognition, or call centers. The data 1404 includes text data from emails, chat logs, customer feedback, news articles or social media posts. The data 1404 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1404 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1402 are communicatively coupled to a data collector 1302. The data collector 1302 gathers relevant data 1404 from the data sources 1402. Once collected, the data collector 1302 may use a pre-processor 1406 to make the data 1404 suitable for analysis. This involves data cleaning, transformation, and feature engineering. Data preprocessing is a step in ML as it directly impacts the accuracy and effectiveness of the ML model 1230. The pre-processor 1406 receives the data 1404 as input, processes the data 1404, and outputs pre-processed data 1416 for storage in a database 1408. Examples for the database 1408 includes a hard drive, solid state storage, and/or random access memory (RAM).

The data collector 1302 is communicatively coupled to a model trainer 1304. The model trainer 1304 performs AI/ML model training, validation, and testing which may generate model performance metrics as part of the model testing procedure. The model trainer 1304 receives the pre-processed data 1416 as input 1410 or via the database 1408. The model trainer 1304 implements a suitable ML algorithm 1424 to train an ML model 1230 on a set of training data 1426 from the pre-processed data 1416. The training process involves feeding the pre-processed data 1416 into the ML algorithm 1424 to produce or optimize an ML model 1230. The training process adjusts its parameters until it achieves an initial level of satisfactory performance.

The model trainer 1304 is communicatively coupled to a model evaluator 1306. After an ML model 1230 is trained, the ML model 1230 needs to be evaluated to assess its performance. This is done using various metrics such as accuracy, precision, recall, and F1 score. The model trainer 1304 outputs the ML model 1230, which is received as input 1410 or from the database 1408. The model evaluator 1306 receives the ML model 1230 as input 1412, and it initiates an evaluation process to measure performance of the ML model 1230. The evaluation process includes providing feedback 1418 to the model trainer 1304. The model trainer 1304 re-trains the ML model 1230 to improve performance in an iterative manner.

The model evaluator 1306 is communicatively coupled to a model inferencer 1308. The model inferencer 1308 provides AI/ML model inference output (e.g., inferences, predictions or decisions). Once the ML model 1230 is trained and evaluated, it is deployed in a production environment where it is used to make predictions on new data. The model inferencer 1308 receives the evaluated ML model 1230 as input 1414. The model inferencer 1308 uses the evaluated ML model 1230 to produce insights or predictions on real data, which is deployed as a final production ML model 1230. The inference output of the ML model 1230 is use case specific. The model inferencer 1308 also performs model monitoring and maintenance, which involves continuously monitoring performance of the ML model 1230 in the production environment and making any necessary updates or modifications to maintain its accuracy and effectiveness. The model inferencer 1308 provides feedback 1418 to the data collector 1302 to train or re-train the ML model 1230. The feedback 1418 includes model performance feedback information, which is used for monitoring and improving performance of the ML model 1230.

Some or all of the model inferencer 1308 is implemented by various actors 1422 in the artificial intelligence architecture 1400, including the ML model 1230 of the inferencing device 1204, for example. The actors 1422 use the deployed ML model 1230 on new data to make inferences or predictions for a given task, and output an insight 1432. The actors 1422 implement the model inferencer 1308 locally, or remotely receives outputs from the model inferencer 1308 in a distributed computing manner. The actors 1422 trigger actions directed to other entities or to itself. The actors 1422 provide feedback 1420 to the data collector 1302 via the model inferencer 1308. The feedback 1420 comprise data needed to derive training data, inference data or to monitor the performance of the ML model 1230 and its impact to the network through updating of key performance indicators (KPIs) and performance counters.

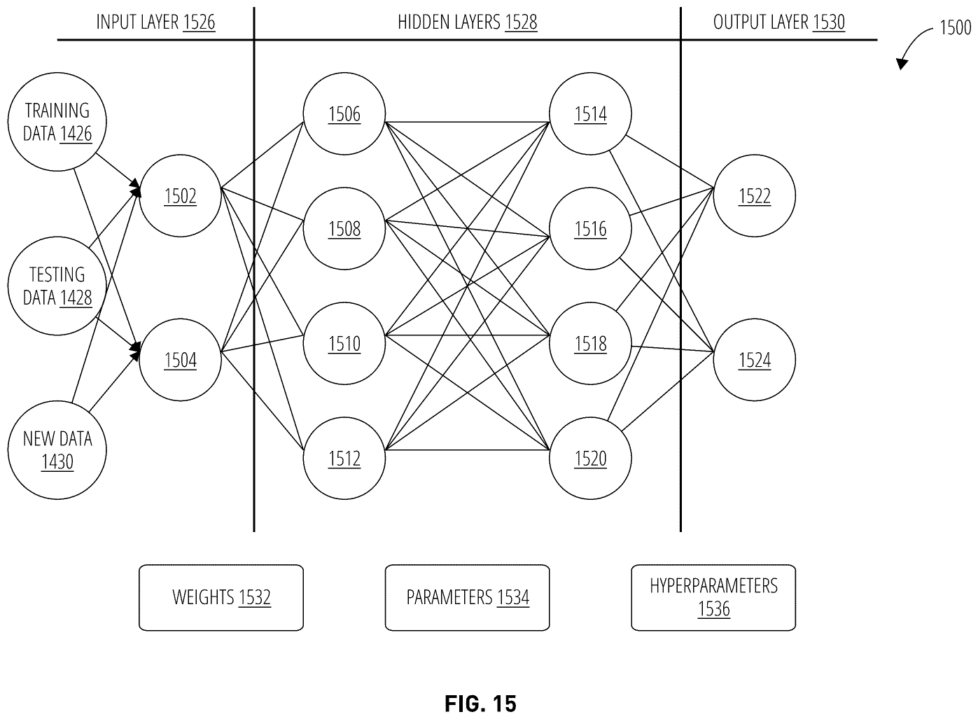

As previously described with reference to FIGS. 1, 2, the systems 1200, 1300 implement some or all of the artificial intelligence architecture 1400 to support various use cases and solutions for various AI/ML tasks. In various embodiments, the training device 1314 of the apparatus 1300 uses the artificial intelligence architecture 1400 to generate and train the ML model 1230 for use by the inferencing device 1204 for the system 1200. In one embodiment, for example, the training device 1314 may train the ML model 1230 as a neural network, as described in more detail with reference to FIG. 15. Other use cases and solutions for AI/ML are possible as well, and embodiments are not limited in this context.

FIG. 15 illustrates an embodiment of an artificial neural network 1500. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1500 comprises multiple node layers, containing an input layer 1526, one or more hidden layers 1528, and an output layer 1530. Each layer comprises one or more nodes, such as nodes 1502 to 1524. As depicted in FIG. 15, for example, the input layer 1526 has nodes 1502, 1504. The artificial neural network 1500 has two hidden layers 1528, with a first hidden layer having nodes 1506, 1508, 1510 and 1512, and a second hidden layer having nodes 1514, 1516, 1518 and 1520. The artificial neural network 1500 has an output layer 1530 with nodes 1522, 1524. Each node 1502 to 1524 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1500 relies on training data 1426 to learn and improve accuracy over time. However, once the artificial neural network 1500 is fine-tuned for accuracy, and tested on testing data 1428, the artificial neural network 1500 is ready to classify and cluster new data 1430 at a high velocity. Tasks in speech recognition or image recognition can take minutes versus hours when compared to the manual identification by human experts.

Each individual node 1502 to 424 is a linear regression model, composed of input data, weights, a bias (or threshold), and an output. The linear regression model may have a formula similar to Equation (1), as follows:

$$\sum wixi + bias = w 1 x 1 + w 2 x 2 + w 3 x 3 + bias \qquad EQUATION ( 1 )$$

$$output = f ( x ) = 1 if \sum w 1 x 1 + b >= 0 ; 0 if \sum w 1 x 1 + b < 0$$

Once an input layer 1526 is determined, a set of weights 1532 are assigned. The weights 1532 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1500 as a feedforward network.

In one embodiment, the artificial neural network 1500 leverages sigmoid neurons, which are distinguished by having values between 0 and 1. Since the artificial neural network 1500 behaves similarly to a decision tree, cascading data from one node to another, having x values between 0 and 1 will reduce the impact of any given change of a single variable on the output of any given node, and subsequently, the output of the artificial neural network 1500.

The artificial neural network 1500 has many practical use cases, like image recognition, speech recognition, text recognition or classification. The artificial neural network 1500 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{m} {( {\hat{y}}_{i} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1534 of the model adjust to gradually converge at the minimum.

In one embodiment, the artificial neural network 1500 is feedforward, meaning it flows in one direction only, from input to output. In one embodiment, the artificial neural network 1500 uses backpropagation. Backpropagation is when the artificial neural network 1500 moves in the opposite direction from output to input. Backpropagation allows calculation and attribution of errors associated with each neuron 1502 to 1524, thereby allowing adjustment to fit the parameters 1534 of the ML model 1230 appropriately.

The artificial neural network 1500 is implemented as different neural networks depending on a given task. Neural networks are classified into different types, which are used for different purposes. In one embodiment, the artificial neural network 1500 is implemented as a feedforward neural network, or multi-layer perceptrons (MLPs), comprised of an input layer 1526, hidden layers 1528, and an output layer 1530. While these neural networks are also commonly referred to as MLPs, they are actually comprised of sigmoid neurons, not perceptrons, as most real-world problems are nonlinear. Trained data 1404 usually is fed into these models to train them, and they are the foundation for computer vision, natural language processing, and other neural networks. In one embodiment, the artificial neural network 1500 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1500 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1500 is implemented as any type of neural network suitable for a given operational task of system 1200, and the MLP, CNN, and RNN are merely a few examples. Embodiments are not limited in this context.

The artificial neural network 1500 includes a set of associated parameters 1534. There are a number of different parameters that may be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1500 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1536. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

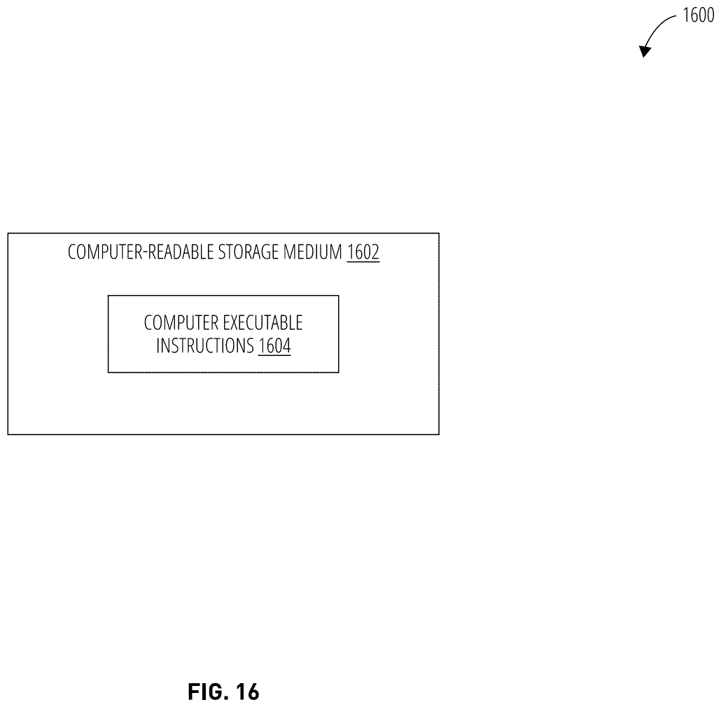

FIG. 16 illustrates an apparatus 1600. Apparatus 1600 comprises any non-transitory computer-readable storage medium 1602 or machine-readable storage medium, such as an optical, magnetic or semiconductor storage medium. In various embodiments, apparatus 1600 comprises an article of manufacture or a product. In some embodiments, the computer-readable storage medium 1602 stores computer executable instructions with which one or more processing devices or processing circuitry can execute. For example, computer executable instructions 1604 includes instructions to implement operations described with respect to any logic flows described herein. Examples of computer-readable storage medium 1602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1604 include any suitable type of code, such as source code, compiled code, interpreted code, executable code, static code, dynamic code, object-oriented code, visual code, and the like.

FIG. 17 illustrates an embodiment of a computing architecture 1700. Computing architecture 1700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1700 has a single processor with one core or more than one processor. Note that the term “processor” refers to a processor with a single core or a processor package with multiple processor cores. In at least one embodiment, the computing computing architecture 1700 is representative of the components of the system 1200. More generally, the computing computing architecture 1700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1700. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 17, computing architecture 1700 comprises a system-on-chip (SoC) 1702 for mounting platform components. System-on-chip (SoC) 1702 is a point-to-point (P2P) interconnect platform that includes a first processor 1704 and a second processor 1706 coupled via a point-to-point interconnect 1770 such as an Ultra Path Interconnect (UPI). In other embodiments, the computing architecture 1700 is another bus architecture, such as a multi-drop bus. Furthermore, each of processor 1704 and processor 1706 are processor packages with multiple processor cores including core(s) 1708 and core(s) 1710, respectively. While the computing architecture 1700 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1704 and chipset 1732. Some platforms include additional components and some platforms include sockets to mount the processors and/or the chipset. Furthermore, some platforms do not have sockets (e.g. SoC, or the like). Although depicted as a SoC 1702, one or more of the components of the SoC 1702 are included in a single die package, a multi-chip module (MCM), a multi-die package, a chiplet, a bridge, and/or an interposer. Therefore, embodiments are not limited to a SoC.

The processor 1704 and processor 1706 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1704 and/or processor 1706. Additionally, the processor 1704 need not be identical to processor 1706.

Processor 1704 includes an integrated memory controller (IMC) 1720 and point-to-point (P2P) interface 1724 and P2P interface 1728. Similarly, the processor 1706 includes an IMC 1722 as well as P2P interface 1726 and P2P interface 1730. IMC 1720 and IMC 1722 couple the processor 1704 and processor 1706, respectively, to respective memories (e.g., memory 1716 and memory 1718). Memory 1716 and memory 1718 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1716 and the memory 1718 locally attach to the respective processors (i.e., processor 1704 and processor 1706). In other embodiments, the main memory couple with the processors via a bus and shared memory hub. Processor 1704 includes registers 1712 and processor 1706 includes registers 1714.

Computing architecture 1700 includes chipset 1732 coupled to processor 1704 and processor 1706. Furthermore, chipset 1732 are coupled to storage device 1750, for example, via an interface (I/F) 1738. The I/F 1738 may be, for example, a Peripheral Component Interconnect-enhanced (PCIe) interface, a Compute Express Link® (CXL) interface, or a Universal Chiplet Interconnect Express (UCIe) interface. Storage device 1750 stores instructions executable by circuitry of computing architecture 1700 (e.g., processor 1704, processor 1706, GPU 1748, accelerator 1754, vision processing unit 1756, or the like). For example, storage device 1750 can store instructions for the client device 1202, the client device 1206, the inferencing device 1204, the training device 1314, or the like.

Processor 1704 couples to the chipset 1732 via P2P interface 1728 and P2P 1734 while processor 1706 couples to the chipset 1732 via P2P interface 1730 and P2P 1736. Direct media interface (DMI) 1776 and DMI 1778 couple the P2P interface 1728 and the P2P 1734 and the P2P interface 1730 and P2P 1736, respectively. DMI 1776 and DMI 1778 is a high-speed interconnect that facilitates, e.g., eight Giga Transfers per second (GT/s) such as DMI 3.0. In other embodiments, the processor 1704 and processor 1706 interconnect via a bus.

The chipset 1732 comprises a controller hub such as a platform controller hub (PCH). The chipset 1732 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1732 comprises more than one controller hub such as a chipset with a memory controller hub, a graphics controller hub, and an input/output (I/O) controller hub.

In the depicted example, chipset 1732 couples with a trusted platform module (TPM) 1744 and UEFI, BIOS, FLASH circuitry 1746 via I/F 1742. The TPM 1744 is a dedicated microcontroller designed to secure hardware by integrating cryptographic keys into devices. The UEFI, BIOS, FLASH circuitry 1746 may provide pre-boot code. The I/F 1742 may also be coupled to a network interface circuit (NIC) 1780 for connections off-chip.

Furthermore, chipset 1732 includes the I/F 1738 to couple chipset 1732 with a high-performance graphics engine, such as, graphics processing circuitry or a graphics processing unit (GPU) 1748. In other embodiments, the computing architecture 1700 includes a flexible display interface (FDI) (not shown) between the processor 1704 and/or the processor 1706 and the chipset 1732. The FDI interconnects a graphics processor core in one or more of processor 1704 and/or processor 1706 with the chipset 1732.

The computing architecture 1700 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1754 and/or vision processing unit 1756 are coupled to chipset 1732 via I/F 1738. The accelerator 1754 is representative of any type of accelerator device (e.g., a data streaming accelerator, cryptographic accelerator, cryptographic co-processor, an offload engine, etc.). One example of an accelerator 1754 is the Intel® Data Streaming Accelerator (DSA). The accelerator 1754 is a device including circuitry to accelerate copy operations, data encryption, hash value computation, data comparison operations (including comparison of data in memory 1716 and/or memory 1718), and/or data compression. Examples for the accelerator 1754 include a USB device, PCI device, PCIe device, CXL device, UCIe device, and/or an SPI device. The accelerator 1754 also includes circuitry arranged to execute machine learning (ML) related operations (e.g., training, inference, etc.) for ML models. Generally, the accelerator 1754 is specially designed to perform computationally intensive operations, such as hash value computations, comparison operations, cryptographic operations, and/or compression operations, in a manner that is more efficient than when performed by the processor 1704 or processor 1706. Because the load of the computing architecture 1700 includes hash value computations, comparison operations, cryptographic operations, and/or compression operations, the accelerator 1754 greatly increases performance of the computing architecture 1700 for these operations.

The accelerator 1754 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1754. For example, the accelerator 1754 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1754 via a non-posted write (e.g., a deferred memory write (DMWr)). One example of an instruction that atomically submits a work descriptor to the shared work queue of the accelerator 1754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1754. The dedicated work queue may accept job submissions via commands such as the movdir64b instruction.

Various I/O devices 1760 and display 1752 couple to the bus 1772, along with a bus bridge 1758 which couples the bus 1772 to a second bus 1774 and an I/F 1740 that connects the bus 1772 with the chipset 1732. In one embodiment, the second bus 1774 is a low pin count (LPC) bus. Various input/output (I/O) devices couple to the second bus 1774 including, for example, a keyboard 1762, a mouse 1764 and communication devices 1766.

Furthermore, an audio I/O 1768 couples to second bus 1774. Many of the I/O devices 1760 and communication devices 1766 reside on the system-on-chip (SoC) 1702 while the keyboard 1762 and the mouse 1764 are add-on peripherals. In other embodiments, some or all the I/O devices 1760 and communication devices 1766 are add-on peripherals and do not reside on the system-on-chip (SoC) 1702.

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, power supplies, and so forth. The embodiments, however, are not limited to implementation by the communications architecture 1800.

As shown in FIG. 18, the communications architecture 1800 includes one or more clients 1802 and servers 1804. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 communicate information between each other using a communication framework 1806. The communication framework 1806 implements any well-known communications techniques and protocols. The communication framework 1806 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1806 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1802 and the servers 1804. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

What is claimed is:

1. A method, comprising:
receiving, using at least one processor, data from one or more sensors monitoring one or more building systems or devices, the one or more sensors configured to detect anomalies for the one or more building systems or devices;
detecting, using the at least one processor, an anomaly in at least one of the one or more monitored building systems or devices based on the data received from the one or more sensors;
in response to the anomaly, identifying, using the at least one processor, a path to a location of at least one of the one or more monitored building systems or devices associated with the detected anomaly; and
automatically reconfiguring, using the at least one processor, at least one access permission for one or more secure access points located in the identified path to allow an authorized entity to access the location of the at least one of the one or more monitored building systems or devices.

2. The method of claim 1, wherein the one or more sensors are configured to detect the anomalies of different types.

3. The method of claim 1, automatically initiating a communication to the authorized entity responsible for the malfunctioning device to coordinate a corrective action, wherein the communication comprises a phone call, a text message, a multimedia message, an electronic mail (email) or combination thereof.

4. The method of claim 1, wherein automatically reconfiguring access permissions comprises the access control system generating a unique, time-limited access code and securely communicating the access code to the authorized entity.

5. The method of claim 1, wherein automatically reconfiguring access permissions comprises the access control system scheduling an automatic unlocking of the one or more secure access points along the identified physical path for a specified period.

6. The method of claim 1, wherein automatically reconfiguring access permissions comprises dynamically updating access rights associated with the authorized entity's pre-existing identifying information.

7. The method of claim 1, wherein detecting the anomaly comprises utilizing machine learning algorithms to analyze processed sensor data and identify deviations from normal operating patterns.

8. The method of claim 1, wherein automatically identifying the physical path comprises utilizing digital representations of the building, comprising two dimensional (2D) floor plans, three dimensional (3D) floor plans, or combination thereof, and employing pathfinding algorithms.

9. The method of claim 8, wherein the pathfinding algorithms include A* or Dijkstra's algorithm.

10. The method of claim 1, wherein automatically identifying the physical path further comprises utilizing one or more Indoor Positioning Systems (IPS) to determine the starting location of the authorized entity or to refine the identified physical path.

11. The method of claim 1, further comprising identifying the authorized entity by accessing a data store or technician database that associates devices with maintenance personnel, owners, or other entities.

12. The method of claim 1, further comprising automatically implementing a short-term corrective in response to the detected anomaly, wherein the short-term corrective action includes disabling the device.

13. A device comprising:
a processing chip comprising logic configured to:
receive sensor data from at least one sensor monitoring one or more systems or devices in a building;
analyze, in real-time, the received sensor data using a machine learning model to identify an anomaly in the one or more monitored systems or devices, the machine learning model has been trained using at least one dataset of normal and anomalous sensor readings; and
generate an on-device decision based on the identified anomaly,
wherein the on-device decision includes initiating a remedial response.

14. The device of claim 13, wherein the logic configured to execute the instructions to identify an anomaly is further configured to compare an output of the machine learning model, the output comprising an anomaly score, against a pre-defined or dynamically adjustable threshold to register the anomaly.

15. The device of claim 13, wherein the remedial response comprises logic configured to execute the instructions to initiate disabling the monitored equipment or the device.

16. The device of claim 13, wherein the remedial response comprises logic configured to execute the instructions to initiate notifying an authorized entity about the identified anomaly comprising sending a communication via email, text message, or a messaging application, the communication including details of the anomaly and the monitored equipment or the device.

17. The device of claim 13, wherein the remedial response comprises logic configured to execute the instructions to initiate scheduling of an authorized entity to address the identified anomaly.

18. The device of claim 17, wherein the remedial response further comprises logic configured to execute the instruction initiate granting temporary access rights to the scheduled authorized entity by dynamically adjusting access permissions for secure access points along a path to the monitored equipment or the device.

19. The device of claim 13, further comprising logic configured to receive and implement over-the-air (OTA) updates for the trained machine learning model from a services platform system.

20. The device of claim 13, wherein the processing chip is integrated within the at least one sensor or within a smart device connected to the at least one sensor.

21. A method to perform localized anomaly detection and automated remedial action within a monitored system, comprising:
receiving, by a processing chip, real-time sensor data from one or more sensors monitoring one or more systems or devices in a building, the sensor data reflecting one or more environmental conditions associated with the one or more monitored systems or devices;
analyzing, by the processing chip, the received real-time sensor data using a machine learning model to identify a deviation from one or more established normal operational patterns, wherein the identified deviation surpassing a predefined or dynamically adjusted threshold, the machine learning model has been trained using a dataset encompassing at least one of: one or more normal operational patterns and one or more known anomalous sensor readings; and
autonomously initiating, by the processing chip, one or more on-device decisions as a remedial response upon identification of an anomaly.
